(19) United States
(12) Patent Application Publication
(10) Pub. No.: US 2026/0360644 A1
(43) Pub. Date: Nov. 12, 2026

(54) RELAY, CONTROL DEVICE AND CONTROL CIRCUIT MODULE

(71) Applicant: Xiamen Hongfa Electric Power Controls Co., Ltd., Xiamen (CN)

(72) Inventors: Yaosheng Hong, Xiamen (CN); Jinpin Chen, Xiamen (CN); Wenguang Dai, Xiamen (CN); Songsheng Chen, Xiamen (CN)

(21) Appl. No.: 19/125,103

(22) PCT Filed: Oct. 9, 2023
(86) PCT No.: PCT/CN2023/123612

§ 371 Date: Apr. 28, 2025

(30) Foreign Application Priority Data
Oct. 27, 2022 (CN) 202211326647.4
Oct. 27, 2022 (CN) 202211329263.8
Oct. 27, 2022 (CN) 202222842938.0

(51) Int. Cl. H01H 47/02; H01H 50/02; H01H 50/16; H01H 50/44

(52) U.S. Cl. CPC H01H 47/02; H01H 50/021; H01H 50/16; H01H 50/443

(57) ABSTRACT

A relay includes a coil configured to electrically connect to an external control circuit; and a capacitor connected to the coil, wherein when the coil is configured to electrically connect to the external control circuit, the capacitor is not connected in series with the coil.

### CROSS-REFERENCE

This disclosure is the U.S. national phase application of International Application No. PCT/CN 2023/123612, filed on Oct. 9, 2023, which claims priority to Chinese patent applications No. 202211326647.4, No. 202211329263.8, and No. 202222842938.0, all titled Relay, Control Device, and Control Circuit Module, and all filed on Oct. 27, 2022. The entire contents of these Chinese patent applications are incorporated herein by reference.

### TECHNICAL FIELD

This disclosure relates to the field of relay technology, and particularly to a high-voltage DC relay, a control device, and a control circuit module.

### BACKGROUND

A relay is an electronic control device that functions as a switch for controlling load circuits. In related technologies, when signals of different frequencies are input into the high-voltage load end, the signals can couple and conduct through the relay's magnetic components and air medium to the low-voltage coil end, causing electromagnetic interference to the coil end. Moreover, with technological advancements, the frequency of signals (e.g., current frequency) input into the load circuit continues to increase. If the signals coupled and conducted from the high-voltage load end to the coil end through the relay's magnetic components and air medium are too strong, they may interfere with other control components in the coil circuit, leading to mis-operation and signal interference, thereby increasing interference at the coil end.

### SUMMARY

According to one aspect of the present disclosure, a relay is provided, including a coil and an anti-interference element. The coil is electrically connected to an external control circuit, and the anti-interference element is connected to the coil. When the coil is electrically connected to the external control circuit, the coil and the anti-interference element are connected in series in the external control circuit.

In some embodiments of the present disclosure, the anti-interference element is at least one of a magnetic bead and an inductor.

In some embodiments of the present disclosure, the relay further includes:
a bobbin, wherein the coil is wound around the bobbin;
a first connector, which is conductive and disposed on the bobbin, having a first end and a second end. The first end is configured to connect to one pole of a power supply of the external control circuit, and the second end is connected to one end of the anti-interference element;
a second connector, which is conductive and disposed on the bobbin, having a third end and a fourth end. The third end is connected to the other end of the anti-interference element, and the fourth end is connected to one end of the coil;
   the other end of the coil is configured to connect to the other pole of the power supply of the external control circuit, so that the coil and the anti-interference element form a loop when electrically connected to the external control circuit.

In some embodiments of the present disclosure, the relay further includes:
a third connector, which is conductive and disposed on the bobbin, having a fifth end and a sixth end. The fifth end is connected to the other end of the coil, and the sixth end is configured to connect to the other pole of the power supply of the external control circuit.

In some embodiments of the present disclosure, the bobbin includes a winding part, a first flange, and a second flange. The first flange and the second flange are located at two sides of the winding part and protrude outward. The first connector includes a first lead-out part and a conductive column, wherein the conductive column is vertically connected to one end of the first lead-out part. A portion of the first connector is embedded in the first flange, the first lead-out part extends vertically and protrudes from the bottom of the first flange, and the conductive column extends along a first horizontal direction and protrudes from the side of the first flange. A portion of the first lead-out part protruding from the first flange serves as the first end of the first connector, and a portion of the conductive column protruding from the first flange serves as the second end of the first connector.

In some embodiments of the present disclosure, the second connector is U-shaped and includes a first connection portion, a second connection portion, and a third connection portion connected in sequence. At least the second connection portion is embedded in the first flange of the bobbin, and the first connection portion and the third connection portion extend along the first horizontal direction and protrude from the side of the first flange. A portion of the first connection portion protruding from the first flange serves as the third end of the second connector, and a portion of the third connection portion protruding from the first flange serves as the fourth end of the second connector.

In some embodiments of the present disclosure, the first connector and the second connector are located at the same side of the first flange, and the first connection portion, the third connection portion, and the conductive column are spaced apart along a second horizontal direction.

In some embodiments of the present disclosure, an edge of the first flange corresponding to the third connection portion is provided with a groove, and the third connection portion protrudes from the groove. The third connection portion is flexible and, after the third connection portion connects to one end of the coil, the third connection portion is configured to be bendable to extend along the vertical direction.

In some embodiments of the present disclosure, the relay further includes a circuit board, wherein the anti-interference element is disposed on the circuit board. The circuit board includes a first through-hole and a second through-hole, wherein the second end of the first connector passes through the first through-hole and protrudes from the circuit board, and the third end of the second connector passes through the second through-hole and protrudes from the circuit board.

In some embodiments of the present disclosure, the number of anti-interference elements is one or more.

Embodiments of the present disclosure also provide a control device, including a control circuit and a relay. The relay includes a coil and an anti-interference element, wherein the anti-interference element and the coil are connected in series in the control circuit.

Embodiments of the present disclosure also provide a control circuit module for controlling an electronic component, including a control circuit and an anti-interference element. The control circuit is electrically connected to the electronic component, and the anti-interference element is electrically connected in the control circuit and configured to connect in series with the electronic component.

In some embodiments of the present disclosure, the electronic component is a relay, and the control circuit is electrically connected to the coil of the relay.

From the above technical solutions, the present disclosure has at least one of the following advantages and positive effects:

In the embodiments of the present disclosure, when the relay is in operation, the anti-interference element and the coil are connected in series in the external control circuit, which can significantly reduce and shield interference signals of different frequencies input from the load end and conducted to the coil, ensuring normal operation of the relay.

According to another aspect of the present disclosure, a relay is provided, including a coil, an anti-interference element, and a capacitor. The anti-interference element and the coil are connected in series to form a series-connected assembly, which is electrically connected to an external control circuit. The capacitor is connected to the series-connected assembly, and when the series-connected assembly is electrically connected to the external control circuit, the capacitor is not connected in series with the series-connected assembly.

In some embodiments of the present disclosure, one end of the capacitor is connected to the series-connected assembly, and the other end is grounded.

In some embodiments of the present disclosure, the capacitor is connected in parallel with at least one of the coil and the anti-interference element.

In some embodiments of the present disclosure, the anti-interference element is at least one of a magnetic bead and an inductor.

According to some embodiments of the present disclosure, the relay further includes: a bobbin, wherein the coil is wound on the bobbin; a first connector, having conductivity and disposed on the bobbin, the first connector has a first end and a second end, the first end is configured to connect to one pole of a power supply of the external control circuit, the second end is connected to one end of the anti-interference element; a second connector, having conductivity and disposed on the bobbin, the second connector having a third end and a fourth end, the third end is connected to the other end of the anti-interference element, the fourth end is connected to one end of the coil; wherein the other end of the coil is configured to connect to the other pole of the power supply of the external control circuit, such that the series-connected assembly form a loop when electrically connected to the external control circuit.

According to some embodiments of the present disclosure, the relay further includes: a third connector, having conductivity and disposed on the bobbin, wherein the third connector has a fifth end and a sixth end, the fifth end is connected to the other end of the coil, the sixth end is configured to connect to the other pole of the power supply of the external control circuit.

According to some embodiments of the present disclosure, the bobbin includes a winding part, a first flange and a second flange, the first flange and the second flange are located at two sides of the winding part and protruding outward; the first connector has a first lead-out part and a conductive column, the conductive column is vertically connected to one end of the first lead-out part, a portion of the first connector is embedded in the first flange, the first lead-out part extends along the vertical direction and protrudes from the bottom of the first flange, the conductive column extends along the first horizontal direction and protrudes from the side of the first flange; a portion of the first lead-out part protruding from the first flange serves as the first end of the first connector, a portion of the conductive column protruding from the first flange serves as the second end of the first connector.

According to some embodiments of the present disclosure, the second connector is U-shaped and has a first connection portion, a second connection portion and a third connection portion connected in sequence, at least the second connection portion is embedded in the first flange of the bobbin, the first connection portion and the third connection portion both extending along the first horizontal direction and protruding from the side of the first flange; the portion of the first connection portion protruding from the first flange serving as the third end of the second connector, the portion of the third connection portion protruding from the first flange serving as the fourth end of the second connector.

According to some embodiments of the present disclosure, the first connector and the second connector are located at the same side of the first flange, and the first connection portion, the third connection portion and the conductive column are spaced apart along the second horizontal direction.

According to some embodiments of the present disclosure, a groove is provided at an edge of the first flange corresponding to the third connection portion, the third connection portion protruding from the groove; the third connection portion has flexibility, and after the third connection portion is connected to one end of the coil, the third connection portion is configured to be bendable to extend along the vertical direction.

According to some embodiments of the present disclosure, the second end of the first connector is further connected to one end of the capacitor, the other end of the capacitor is grounded.

According to some embodiments of the present disclosure, the relay further includes: a yoke base, the bobbin is placed on the yoke base; a lead-out member, one end of which is connected to the side wall of the yoke base, the other end is connected to the other end of the capacitor.

According to some embodiments of the present disclosure, the yoke base has at least two opposite first sidewall and second sidewall, and a bottom wall connected to the first sidewall and the second sidewall, the first sidewall, the second sidewall and the bottom wall forming a chamber, the bobbin is disposed in the chamber and placed on the bottom wall; one end of the lead-out member is connected to the first sidewall of the yoke base near the capacitor, the other end is connected to the other end of the capacitor.

According to some embodiments of the present disclosure, the lead-out member has a first lead-out portion, a second lead-out portion and a third lead-out portion connected in sequence, the first lead-out portion and the third lead-out portion is located at opposite sides of the second lead-out portion; the first sidewall of the yoke base is provided with an accommodating slot, the first lead-out portion is fixedly disposed in the accommodating slot, the third lead-out portion is connected to the capacitor.

According to some embodiments of the present disclosure, the relay further includes a circuit board, the anti-interference element and the capacitor is disposed on the circuit board, the circuit board having a first through-hole, a second through-hole and a third through-hole, the second end of the first connector passing through the first through-hole and protruding from the circuit board, the third end of the second connector passing through the second through-hole and protruding from the circuit board, the third lead-out portion of the lead-out member passing through the third through-hole and protruding from the circuit board.

According to some embodiments of the present disclosure, the number of the anti-interference element is one or more; the number of the capacitor is one or more.

The embodiments of the present disclosure further provide a control device, including a control circuit and a relay. The relay includes a coil, an anti-interference element and a capacitor; wherein the anti-interference element is connected in series with the coil to form a series-connected assembly, the series-connected assembly is connected in the control circuit; the capacitor is connected to the series-connected assembly, and the capacitor is not connected in series with the series-connected assembly in the control circuit.

The embodiments of the present disclosure further provide a control circuit module for controlling an electronic component, the control circuit module including: a control circuit, configured to electrically connect to the electronic component; an anti-interference element, electrically connected in the control circuit and configured to connect in series with the electronic component; a capacitor, electrically connected to the control circuit, wherein when the control circuit is electrically connected to the electronic component, the capacitor is not connected in series with the electronic component and the anti-interference element.

According to some embodiments of the present disclosure, the electronic component is a relay, and the control circuit is configured to electrically connect to the coil of the relay.

From the above technical solutions, the present disclosure has at least one of the following advantages and positive effects:

In the embodiments of the present disclosure, when the relay operates, the anti-interference element and the coil are connected in series to form a series-connected assembly, which can significantly reduce and shield high-frequency interference signals transmitted from the load side to the coil, while the capacitor is connected to the series-connected assembly but not in series with it, which can significantly reduce and shield low-frequency interference signals transmitted from the load side to the coil, thereby comprehensively shielding interference signals of different frequencies and ensuring normal operation of the relay.

According to another aspect of the present disclosure, a relay is provided, including a coil and a capacitor. Wherein the coil is configured to electrically connect to an external control circuit; the capacitor is connected to the coil, and when the coil is configured to electrically connect to the external control circuit, the capacitor is not connected in series with the coil.

According to some embodiments of the present disclosure, one end of the capacitor is connected to the coil, and another end is grounded.

According to some embodiments of the present disclosure, the capacitor is connected in parallel with the coil.

According to some embodiments of the present disclosure, the relay further includes:
a bobbin, wherein the coil is wound on the bobbin;
a first connector having conductivity and disposed on the bobbin, wherein the first connector has a first end and a second end, the first end is configured to connect to one pole of a power supply of an external control circuit, the second end is connected to one end of the capacitor;
a second connector, having conductivity and disposed on the bobbin, the second connector having a third end and a fourth end, the third end is connected to the second end of the first connector, and the fourth end is connected to one end of the coil;
wherein the other end of the coil is configured to connect to the other pole of the power supply of the external control circuit, such that the coil forms a loop when electrically connected to the external control circuit.

According to some embodiments of the present disclosure, the relay further includes:
a third connector having conductivity and disposed on the bobbin, wherein the third connector has a fifth end and a sixth end, the fifth end is connected to another end of the coil, and the sixth end is configured to connect to the other pole of the power supply of the external control circuit.

According to some embodiments of the present disclosure, the bobbin includes a winding part, a first flange and a second flange, the first flange and the second flange are located at two sides of the winding part and protruding outward; the first connector has a first lead-out part and a conductive column, the conductive column is vertically connected to one end of the first lead-out part, a portion of the first connector is embedded in the first flange, the first lead-out part extends along a vertical direction and protrudes from a bottom of the first flange, the conductive column extends along a first horizontal direction and protrudes from a side of the first flange; a portion of the first lead-out part protruding from the first flange serves as the first end of the first connector, a portion of the conductive column protruding from the first flange serves as the second end of the first connector.

According to some embodiments of the present disclosure, the second connector is U-shaped and has a first connection portion, a second connection portion and a third connection portion connected in sequence, at least the second connection portion is embedded in the first flange of the bobbin, the first connection portion and the third connection portion both extend along the first horizontal direction and protrude from the side of the first flange; a portion of the first connection portion protruding from the first flange servs as the third end of the second connector, a portion of the third connection portion protruding from the first flange servs as the fourth end of the second connector.

According to some embodiments of the present disclosure, a groove is provided at an edge of the first flange corresponding to the third connection portion, the third connection portion protrudes from the groove; the third connection portion has flexibility, and after the third connection portion is connected to one end of the coil, the third connection portion is configured to be bendable to extend along the vertical direction.

According to some embodiments of the present disclosure, the first connector and the second connector are located at the same side of the first flange, and the first connection portion, the third connection portion and the conductive column are spaced apart along the second horizontal direction.

According to some embodiments of the present disclosure, the relay further includes a yoke base, wherein the bobbin is placed on the yoke base; and a lead-out member, one end of the lead-out member is connected to the side wall of the yoke base, another end is connected to another end of the capacitor.

According to some embodiments of the present disclosure, the yoke base at least has a first sidewall and a second sidewall opposite with each other, and a bottom wall connected to the first sidewall and the second sidewall, the first sidewall, the second sidewall and the bottom wall together form a chamber, the bobbin is disposed in the chamber and placed on the bottom wall; one end of the lead-out member is connected to the first sidewall of the yoke base near the capacitor.

According to some embodiments of the present disclosure, the lead-out member has a first lead-out portion, a second lead-out portion and a third lead-out portion connected in sequence, the first lead-out portion and the third lead-out portion are located at opposite sides of the second lead-out portion; the first sidewall of the yoke base is provided with an accommodating slot, the first lead-out portion is fixedly disposed in the accommodating slot, and the third lead-out portion is connected to the capacitor.

According to some embodiments of the present disclosure, the relay further includes a circuit board, the capacitor is disposed on the circuit board, wherein the circuit board has a first through-hole, a second through-hole and a third through-hole, the second end of the first connector passes through the first through-hole and protrudes from the circuit board, the third end of the second connector passes through the second through-hole and protrudes from the circuit board, the third lead-out portion of the lead-out member passes through the third through-hole and protrudes from the circuit board.

According to some embodiments of the present disclosure, the number of the capacitor is one or more.

The embodiments of the present disclosure further provide a control device, including a control circuit and a relay. The relay includes a coil and a capacitor; wherein the coil is electrically connected in the control circuit, the capacitor is connected to the coil, and the capacitor is not connected in series with the coil in the control circuit.

The embodiments of the present disclosure further provide a control circuit module for controlling an electronic component. wherein the control circuit module includes a control circuit and a capacitor. The control circuit is configured to electrically connect to the electronic component; the capacitor is electrically connected to the control circuit, and when the control circuit is electrically connected to the electronic component, the capacitor is not connected in series with the electronic component.

According to some embodiments of the present disclosure, the electronic component is a relay, and the control circuit is configured to electrically connect to the coil of the relay.

From the above technical solutions, the present disclosure has at least one of the following advantages and positive effects:

In the embodiments of the present disclosure, when the relay is in operation, the coil is electrically connected to the external control circuit, and the capacitor is connected to the coil but not in series with it, meaning the capacitor is also electrically connected to the control circuit. This configuration can effectively reduce and shield interference signals of various frequencies transmitted from the load side to the coil, ensuring normal operation of the relay.

### BRIEF DESCRIPTION OF THE DRAWINGS

The above and other features and advantages of the present disclosure will become more apparent by describing in detail exemplary embodiments thereof with reference to the accompanying drawings.

FIG. 1 is a schematic circuit diagram of a relay in an operating state according to some embodiments of the present disclosure.

FIG. 2 is a perspective view of a relay (with the housing omitted) according to some embodiments of the present disclosure.

FIG. 3 is an enlarged view of part C in FIG. 2.

FIG. 4 is a top view of the relay according to some embodiments of the present disclosure.

FIG. 5 is a cross-sectional view taken along line A-A in FIG. 4.

FIG. 6 is a front view of the relay according to some embodiments of the present disclosure.

FIG. 7 is a side view of the relay according to some embodiments of the present disclosure.

FIG. 8 is a structural diagram of the bobbin, the first connector, the second connector, and a third connector according to some embodiments of the present disclosure.

FIG. 9 is a cross-sectional view taken along line B-B in FIG. 8.

FIG. 10 is a structural diagram of the first connector according to some embodiments of the present disclosure.

FIG. 11 is a structural diagram of the second connector according to some embodiments of the present disclosure.

FIG. 12 is a schematic diagram of an anti-interference element disposed on a circuit board according to some embodiments of the present disclosure.

FIG. 13 is a schematic diagram of a control device according to some embodiments of the present disclosure.

FIG. 14 is a schematic diagram of a control circuit module according to some embodiments of the present disclosure.

FIG. 15 is a schematic circuit diagram of the relay in an operating state according to some embodiments of the present disclosure.

FIG. 16 is a perspective view of the relay (with the housing omitted) according to some embodiments of the present disclosure.

FIG. 17 is an enlarged view of part E in FIG. 16.

FIG. 18 is a top view of the relay according to some embodiments of the present disclosure.

FIG. 19 is a cross-sectional view taken along line D-D in FIG. 18.

FIG. 20 is a front view of the relay according to some embodiments of the present disclosure.

FIG. 21 is a side view of the relay according to some embodiments of the present disclosure.

FIG. 22 is a structural diagram of the lead-out member according to some embodiments of the present disclosure.

FIG. 23 is a structural diagram of the lead-out member disposed on a yoke base according to some embodiments of the present disclosure.

FIG. 24 is a side view of the lead-out member disposed on the yoke base according to some embodiments of the present disclosure.

FIG. 25 is a schematic diagram of the anti-interference element and capacitor disposed on the circuit board according to some embodiments of the present disclosure.

FIG. 26 is a schematic diagram of the control device according to some embodiments of the present disclosure.

FIG. 27 is a schematic diagram of the control circuit module according to some embodiments of the present disclosure.

FIG. 28 is a schematic circuit diagram of the relay in an operating state according to some embodiments of the present disclosure.

FIG. 29 is a perspective view of the relay (with the housing omitted) according to some embodiments of the present disclosure.

FIG. 30 is an enlarged view of part F in FIG. 29.

FIG. 31 is a front view of the relay according to some embodiments of the present disclosure.

FIG. 32 is a schematic diagram of the capacitor disposed on the circuit board according to some embodiments of the present disclosure.

FIG. 33 is a schematic diagram of the control device according to some embodiments of the present disclosure.

FIG. 34 is a schematic diagram of the control circuit module according to some embodiments of the present disclosure.

### Reference Numerals

1. Magnetic circuit unit, 11. Coil, 12. Bobbin, 121. First flange, 1211. Groove, 122. Winding part, 123. Second flange, 13. Push rod assembly, 131. Push rod, 132. Support bracket, 133. First spring, 14. Stationary core, 15. Movable core, 16. Second spring, 2. Contact unit, 21. Static contact leading-out terminal, 22. Movable contact piece, 23. Insulating cover, 24. Frame member, 25. Yoke plate, 26. Chamber, 3. Arc extinguishing unit, 31. Arc extinguishing magnet, 32. Yoke clip, 4. Control circuit module, 41. Control circuit, 42. Anti-interference element, 43. Capacitor, 44. Resistor, 51. First connector, 511. First lead-out part, 512. Conductive column, 52. Second connector, 521. First Connection portion, 522. Second connection portion, 523. Third connection portion, 53. Third connector, 531. Second lead-out part, 532. Winding column, 54. Circuit board, 541. First through-hole, 542. Second through-hole, 6. Yoke base, 61. First sidewall, 62. Second sidewall, 63. Bottom wall, X. First horizontal direction, Y. Second horizontal direction, Z. Vertical direction,

### DETAILED DESCRIPTION

Reference will now be made in detail to exemplary embodiments, examples of which are illustrated in the accompanying drawings. However, the exemplary embodiments may be implemented in various forms and should not be construed as limited to the embodiments set forth herein. Rather, these embodiments are provided to make this disclosure thorough and complete, and to fully convey the concepts of the exemplary embodiments to those skilled in the art. Throughout the drawings, like reference numerals denote like or similar structures, and thus their detailed descriptions will be omitted.

A relay is an electronic control device typically used to switch high-voltage load circuits. During operation, the coil terminals of the relay are connected to an external control circuit (referred to as a low-voltage control circuit or coil-side control circuit) to energize the coil. The terms “low-voltage” and “high-voltage” are relative; in essence, a relay functions as an “automatic switch” that uses a smaller current to control a larger one, playing roles in automatic regulation, safety protection, and circuit switching in load circuits.

High-voltage DC relays are capable of handling high power and, under demanding conditions such as high voltage and large currents, offer higher reliability and longer service life compared to conventional relays, making them widely applicable across various fields.

Taking the application of high-voltage DC relays in new energy vehicles as an example: with increasing demands for extended driving range, battery capacity requirements continue to rise, alongside higher performance expectations for rapid acceleration, emergency braking, and 0-100 km/h acceleration. To meet these demands, the current frequency provided by batteries is constantly increasing, which makes the current frequency span range of the input load increase. For example, signals with different frequencies ranging from 15 kHz to 120 MHz are input at the load end, the expanded frequency range will produce interference signals with different frequencies, such as low-frequency interference signals and high-frequency interference signals at the same time. These interference signals can couple into the relay's low-voltage control circuit such as the coil through magnetic components or air media, which will cause electromagnetic interference to the low-voltage control circuit. Especially when high-frequency signal is input at the load end, excessively strong signals coupled into the coil-side control circuit may disrupt other components, leading to malfunctions and making the relay unable to operate normally. However, in the related art, the above problems have not been effectively solved.

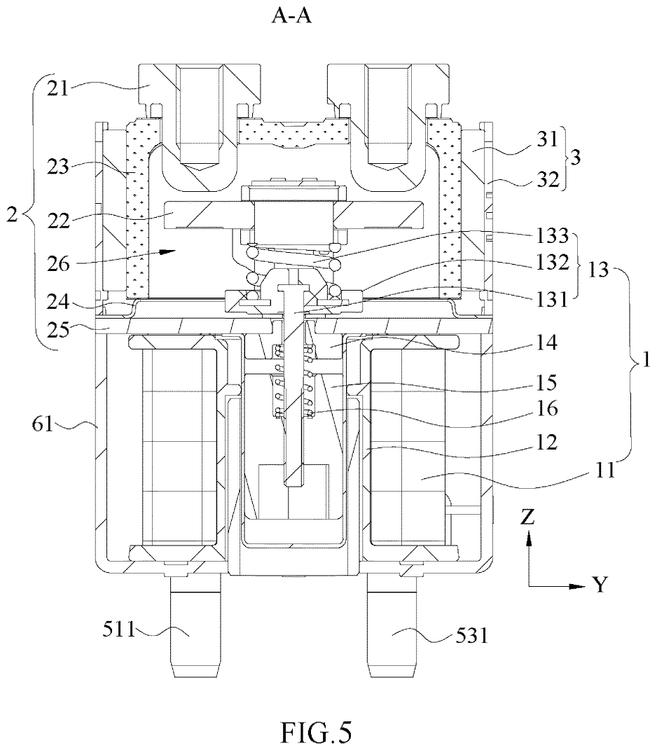

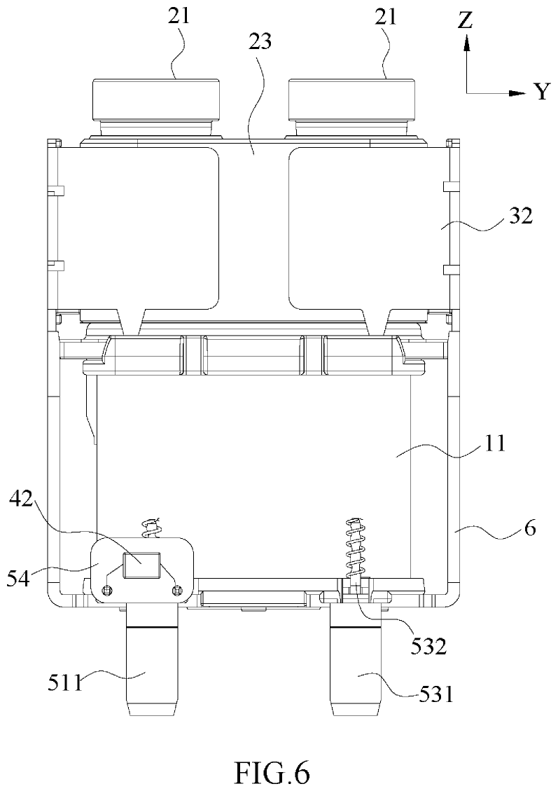

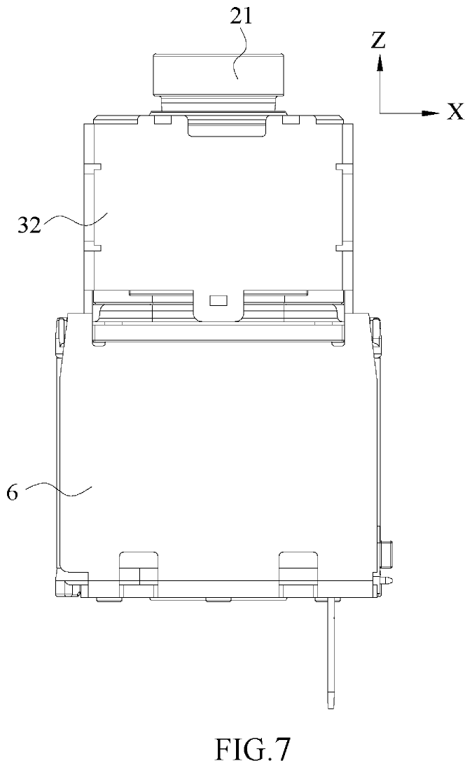

To overcome these challenges, embodiments of the present disclosure provide an improved relay. As shown in FIGS. 2, 4-7, FIG. 2 illustrates a perspective view of the relay (housing omitted), FIG. 4 shows a top view, FIG. 5 presents a cross-sectional view along line A-A in FIG. 4, FIG. 6 depicts a front view, and FIG. 7 displays a side view.

For ease of description, as shown in FIG. 2, the assembled relay is used as a reference to define a height direction of the relay as the vertical direction z, a length direction of the relay as the first horizontal direction x, and a width direction of the relay as the second horizontal direction y. the vertical direction z, first horizontal direction x, and second horizontal direction y are mutually perpendicular with each other, and the first horizontal direction x and second horizontal direction y may lie in the same plane. These directions are merely for facilitating the description of the structure of the relay and do not have limiting meaning.

The relay of the present embodiment includes a housing (not shown in the drawings), a magnetic circuit unit 1, a contact unit 2, and an arc extinguishing unit 3.

In some embodiments, as shown in FIG. 5, the contact unit 2 includes two static contact leading-out terminals 21, a movable contact piece 22, an insulating cover 23, a frame member 24, and a yoke plate 25. The insulating cover 23, the frame member 24, and the yoke plate 25 are assembled to form a chamber 26. The top of the insulating cover 23 is provided with two through-holes, and the two static contact leading-out terminals 21 are respectively inserted through the two through-holes, such that the lower portions of the two static contact leading-out terminals 21 are located in the chamber 26.

Continuing to refer to FIG. 5, the movable contact piece 22 is supported in the chamber 26 by a push rod assembly 13 in the magnetic circuit unit 1, positioned below the two static contact leading-out terminals 21. Both ends of the movable contact piece 22 may serve as movable contacts, which are respectively used to contact the bottom of the two static contact leading-out terminals 21 to achieve contact closure. The tops of the two static contact leading-out terminals 21 are connected to an external load circuit. When the movable contacts are contacted with the two static contact leading-out terminals 21, the current of the load circuit flows from one static contact leading-out terminal 21, passes through the movable contact piece 22, and flows out from the other static contact leading-out terminal 21, thereby connecting the external load circuit. When the movable contacts separate from the two static contact leading-out terminals 21, the load circuit is disconnected.

In the present embodiment, the closing and opening of the movable contacts with the two static contact leading-out terminals 21 are achieved by the movement of the push rod assembly 13 in the magnetic circuit unit 1 driving the movable contact piece 22.
specifically, continuing to refer to FIG. 5, the magnetic circuit unit 1 includes a coil 11 and a bobbin 12. The bobbin 12 is hollow and cylindrical and made of an insulating material. The coil 11 is wound around the bobbin 12. The magnetic circuit unit 1 further includes a push rod assembly 13, which includes a push rod 131, a support bracket 132, and a first spring 133.

The push rod 131 is movably inserted along the axial direction through the bobbin 12, the yoke plate 25, and the chamber 26. the first spring 133 is arranged at one end of the push rod 131 located in the chamber 26, and the support bracket 132 is arranged at the end of the push rod 131 closer to the movable contact piece 22 along the axial direction. at least a portion of the support bracket 132 is located in the chamber 26. The end of the first spring 133 away from the movable contact piece 22 abuts against the support bracket 132. The first spring 133 is used to apply an elastic force to the movable contact piece 22 to move toward the static contact leading-out terminal 21, and after the static contact leading-out terminal 21 contacts the movable contact piece 22, the first spring 133 can continue to be compressed to provide overtravel.

The magnetic circuit unit 1 further includes a stationary core 14, a movable core 15, and a second spring 16. The stationary core 14 is arranged inside the bobbin 12 and fixedly connected to the yoke plate 25, and the push rod 131 is movably inserted through the stationary core 14. The movable core 15 is movably arranged inside the bobbin 12, faced to the stationary core 14, and connected to the end of the push rod 131 located inside the bobbin 12. When the coil 11 is energized, a magnetic field is generated, and the stationary core 14 attracts the movable core 15, causing the movable core 15 to drive the push rod 131 to move toward the static contact leading-out terminal 21, pushing the movable contact piece 22 to contact the static contact leading-out terminal 21, thereby connecting the external load circuit. The second spring 16 is arranged between the stationary core 14 and the movable core 15, sleeved around the outside of the push rod 131. When the movable core 15 moves toward the static contact leading-out terminal 21, the second spring 16 is compressed. When the coil 11 is de-energized, the magnetic field disappears, and the movable core 15 is no longer attracted by the stationary core 14, the second spring 16 applies a reverse elastic force to the movable core 15, causing it to reset quickly, separating the movable contact piece 22 from the static contact leading-out terminal 21, thereby disconnecting the external load circuit.

As shown in FIG. 5, the relay further includes a yoke base 6, which at least has a first sidewalls 61 and a second sidewalls 62 opposite with each other, as well as a bottom wall 63 connected to one end of the first sidewall 61 and the second sidewall 62. The first sidewall 61, the second sidewall 62, and the bottom wall 63 form chamber, with the bobbin 12 positioned in this chamber and placed on the bottom wall 63. The yoke base 6 and the yoke plate 25 enclose a space to house the magnetic circuit unit 1. When the coil 11 is energized and generates a magnetic field, the yoke base 6 can block the magnetic field from dispersing outward, improving magnetic field utilization.

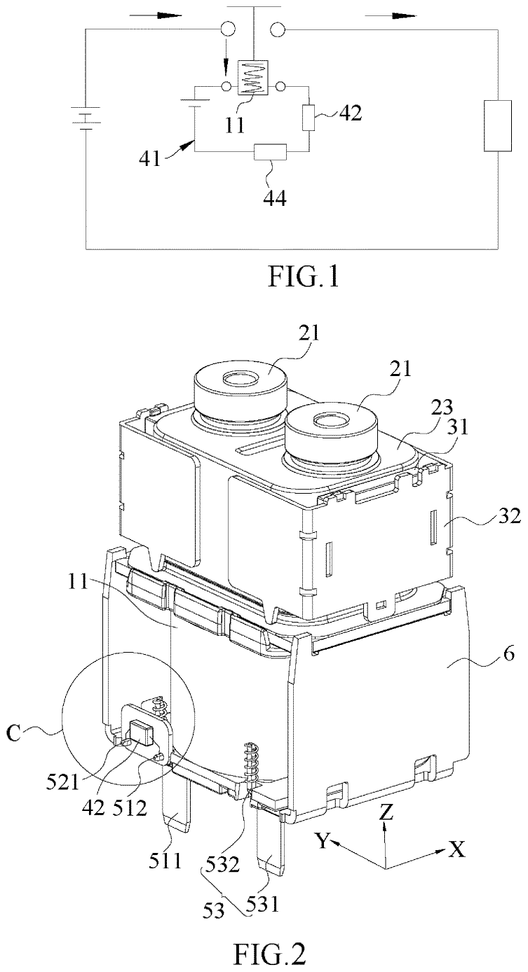

Thus, whether the coil 11 is energized determines the connection and disconnection of the external load circuit. As shown in FIG. 1, when the relay in the present embodiment is in operation, it is connected to an external control circuit 41, which supplies current to the coil 11. Therefore, this control circuit 41 plays a critical role in the normal operation of the relay. The control circuit 41 is the coil-side control circuit mentioned in the above embodiments, i.e., the low-voltage control circuit. Wherein, the word “external” in the external control circuit 41 can be understood as not being included in the relay.

As shown in FIG. 1, when the movable contact piece 22 and the static contact leading-out terminal 21 in the present embodiment are closed, the movable contact piece 22 effectively becomes part of the external load circuit, serving as a conductive path. The current of the load circuit flows in from one static contact leading-out terminal 21, passes through the movable contact piece 22, and flows out from the other static contact leading-out terminal 21. However, due to load requirements, the voltage of the external load circuit is much higher than that of the control circuit 41, and the external load circuit may input signals of varying frequencies. As seen in FIG. 1, these signals of different frequencies can be conducted through magnetic components (e.g., the movable contact piece 22, the stationary core 14, the movable core 15, etc.) to the control circuit 41, interfering with normal operation of the control circuit 41. If the control circuit 41 becomes unstable, it may further affect the accurate contact and separation between the movable contact piece 22 and the static contact leading-out terminal 21.

To address this, as shown in FIG. 1, the relay in the present embodiment further includes an anti-interference element 42, which is connected to the coil 11. When the coil 11 is electrically connected to the external control circuit 41, the coil 11 and the anti-interference element 42 are connected in series within the external control circuit 41.

As shown in FIG. 1, the external control circuit 41 includes a power supply, a resistor 44 (which may be an electronic component), a switch (not shown in FIG. 1), and wiring, forming a loop. When the relay is in operation, both ends of the coil 11 are connected to this external control circuit 41, placing the coil 11 in series with the resistor 44. The anti-interference element 42 is connected within this control circuit 41, in series with the coil 11 and the resistor 44.

In some embodiments, the anti-interference element 42 is at least one of a magnetic bead and an inductor. The magnetic bead is composed of ferrite, while the inductor consists of a magnetic core and a coil. The magnetic bead converts AC signals into heat, while the inductor stores AC energy and releases it slowly. The magnetic bead is primarily used to suppress electromagnetic radiation interference, whereas the inductor focuses on suppressing conductive interference. Both can suppress high-frequency noise and spike interference, absorbing or shielding interference signals of various frequencies.

Depending on the strength and type of interference signals, a magnetic bead may be selected as the anti-interference element 42, or an inductor, or both. The specifications of the magnetic bead and inductor can also be chosen by those skilled in the art based on the specific interference conditions, with no special limitations imposed here.

In the present embodiment, the magnetic bead and/or inductor are integrated into the relay and connected in series with the coil 11. When the relay operates, the anti-interference element is connected in series within the external control circuit, shielding interference signals conducted from the external load circuit to the control circuit 41. This prevents excessive interference signals from affecting the normal operation of components in the control circuit 41, ensuring the relay functions properly. At the same time, when the relay operates, the anti-interference element 42 is also connected in series within the control circuit 41, meaning it does not directly absorb or shield signals from the external load circuit, thereby ensuring the normal operation of the load circuit.

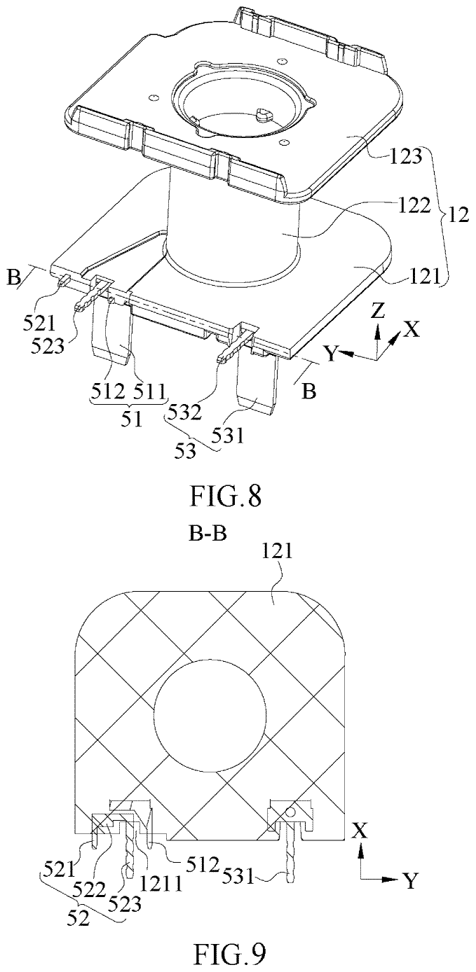

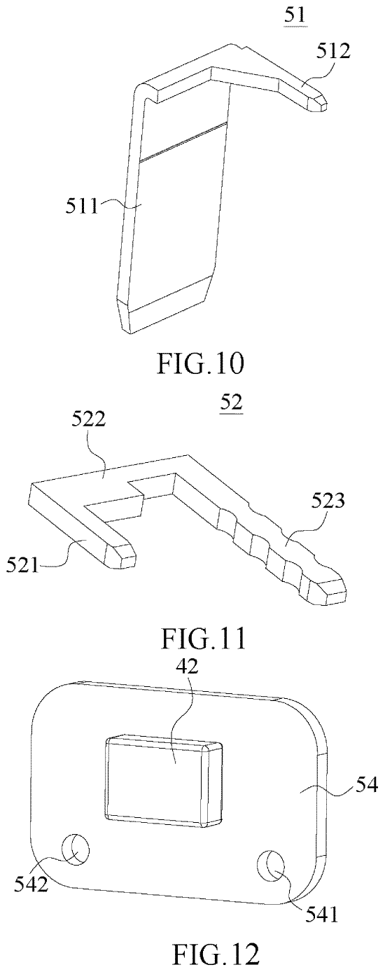

In some embodiments, as shown in FIGS. 8 to 11, the relay further includes a first connector 51 and a second connector 52 for connecting the anti-interference element 42 to the external control circuit 41. FIG. 8 shows a perspective view of the first connector 51 and second connector 52 mounted on the bobbin 12, while FIG. 9 is a cross-sectional view along B-B in FIG. 8, illustrating the positional relationship between the first connector 51 and second connector 52. FIG. 10 shows a perspective view of the first connector 51, and FIG. 11 shows a perspective view of the second connector 52.

As shown in FIGS. 8 to 10, the first connector 51 is conductive and mounted on the bobbin 12. The first connector 51 has a first end and a second end, the first end is connected to one pole of the power supply in the external control circuit 41, while the second end is connected to one end of the anti-interference element 42. The second connector 52 is also conductive and mounted on the bobbin 12. The second connector 52 has a third end and a fourth end, the third end is connected to the other end of the anti-interference element 42, and the fourth end is connected to one end of the coil 11. The other end of the coil 11 is configured to connect to the other pole of the power supply in the external control circuit 41, ensuring that the coil 11 and anti-interference element 42 form a loop when connected to the external control circuit.

In some embodiments, as shown in FIG. 8, the bobbin 12 includes a first flange 121, a winding part 122, and a second flange 123. The first flange 121 and second flange 123 are respectively located at two sides of the winding part 122 and protrude outward.

The winding part 122 may be a hollow cylindrical structure extending along the vertical direction Z, with the first flange 121 and the second flange 123 positioned at opposite sides in the vertical direction Z. The first flange 121 and the second flange 123 located at two sides of the winding part 122 and protruding outward can be understood that the first flange 121 and the second flange 123 extend away from the winding part 122 along the radial direction of the winding part 122.

As shown in FIGS. 8 and 10, the first connector 51 has a first lead-out part 511 and a conductive column 512, with the conductive column 512 perpendicularly connected to one end of the first lead-out part 511. A portion of the first connector 51 is embedded in the first flange 121. The first lead-out part 511 extends along the vertical direction Z and protrudes from the bottom of the first flange 121, while the conductive column 512 extends along the first horizontal direction X and protrudes from the side of the first flange 121.

Specifically, in some embodiments, as shown in FIG. 10, the first lead-out part 511 is plate-shaped and used to connect to the control circuit 41. The conductive column 512 is located at one end of the first lead-out part 511 and perpendicular to the first lead-out part 511. The conductive column 512 and first lead-out part 511 may be integrally formed. The conductive column 512 is used to electrically connect to one end of the anti-interference element 42. In some embodiments, the width of the conductive column 512 is smaller than that of the first lead-out part 511. Referring to FIG. 9, the width of the conductive column 512 refers to its dimension along the second horizontal direction Y, while the width of the first lead-out part 511 refers to its dimension along the second horizontal direction Y. Setting the conductive column 512 narrower than the first lead-out part 511 facilitates wiring and saves space and materials.

The portion of the first lead-out part 511 protruding from the first flange 121 serves as the first end of the first connector 51, connecting to the control circuit 41, while the portion of the conductive column 512 protruding from the first flange 121 serves as the second end, connecting to one end of the anti-interference element 42.

In some embodiments, as shown in FIGS. 8, 9, and 11, the second connector 52 is roughly U-shaped, having a first connection portion 521, a second connection portion 522, and a third connection portion 523 sequentially connected. At least the second connection portion 522 is embedded in the first flange 121 of the bobbin 12, while the first connection portion 521 and third connection portion 523 both extend along the first horizontal direction X and protrude from the side of the first flange 121.

Specifically, as shown in FIG. 11, the second connector 52 is generally U-shaped. The length of the first connection portion 521 is shorter than that of the third connection portion 523. Referring to FIG. 9, the length of the first connection portion 521 refers to its dimension along the first horizontal direction X, while the length of the third connection portion 523 refers to its dimension along the first horizontal direction X. Wherein the third connection portion 523 has serrated edges on both sides along the second horizontal direction Y. so that one end of the coil 11 can be wound around the third connection portion 523 easily, and it is not easy to slip off.

In some embodiments, the portion of the first connection portion 521 protruding from the first flange 121 serves as the third terminal of the second connector 52, connecting to the other end of the anti-interference element 42, while the portion of the third connection portion 523 protruding from the first flange 121 serves as the fourth terminal of the second connector 52, connecting to one end of the coil 11.

In some embodiments, as shown in FIGS. 8 and 9, the first connector 51 and the second connector 52 are located at the same side of the first flange 121. The first connection portion 521 of the second connector 52, the third connection portion 523, and the conductive column 512 of the first connector 51 spaced apart along the second horizontal direction Y.

Specifically, the first connector 51 and second connector 52 are arranged adjacent to each other. As shown in FIG. 9, in some embodiments, the projections of the first lead-out part 511 of the first connector 51 and the second connection portion 522 of the second connector 52 along the first horizontal direction X at least partially overlap, so as to reduce the distance between the first connection portion 521 of the first connector 51 and the conductive column 512 of the second connector 52 along the second horizontal direction Y, thereby minimizing the space occupied by the control circuit 41 connecting the anti-interference element 42 and making the relay structure more compact.

In some embodiments, as shown in FIGS. 8 and 9, an edge of the first flange 121 corresponding to the third connection portion 523 is provided with a groove 1211, and the third connection portion 523 extends outward from the groove 1211. The third connection portion 523 is flexible and can be bent to extend along the vertical direction Z after connecting to one end of the coil 11. That is, one end of the coil 11 can be wound around the third connection portion 523, so as to facilitate connection between the coil 11 and the control circuit 41 and facilitate the storage of the end of the coil 11.

In some embodiments, as shown in FIGS. 8 and 9, the relay further includes a third connector 53. The third connector 53 is conductive and mounted on the bobbin 12, having a fifth terminal and a sixth terminal. The fifth terminal connects to the other end of the coil 11, while the sixth terminal connects to the other pole of the power supply in the external control circuit 41.

Specifically, as shown in FIG. 8, the third connector 53 may include a second lead-out part 531 and a winding column 532. The winding column 532 is perpendicularly connected to one end of the second lead-out part 531, and part of the third connector 53 is embedded in the first flange 121 of the bobbin 12. The second lead-out part 531 extends along the vertical direction Z and protrudes from the bottom of the first flange 121, while the winding part 122 extends along the first horizontal direction X and protrudes from the side of the first flange 121.

In some embodiments, as shown in FIG. 8, the second lead-out part 531 is plate-shaped and connects to the external control circuit 41, serving as the sixth terminal of the third connector 53. The structure of the second lead-out part 531 may be the same as that of the first lead-out part 511. The winding column 532 is located at one end of the second lead-out part 531 and perpendicular to the second lead-out part 531, and may be integrally formed with the second lead-out part 531. The sides of the winding column 532 along the second horizontal direction Y may be serrated. The winding column 532 is connected to the other end of the coil 11. That is, the other end of the coil 11 can be wound around the winding column 532, so as to facilitate connection between the coil 11 and the control circuit 41 and facilitate the storage of the other end of the coil 11. The winding column 532 serves as the fifth terminal of the third connector 53.

Thus, as shown in FIGS. 1 to 3, when the relay is in operation, the first lead-out part 511 and second lead-out part 531 are connected to the control circuit 41. Assuming the second lead-out part 531 connects to the positive pole of the control circuit 41 power supply, current flows sequentially through the second lead-out part 531, the winding column 532, the coil 11, the third connection portion 523, the second connection portion 522, the first connection portion 521, the anti-interference element 42, the conductive column 512, and finally back to the negative pole of the control circuit 41 power supply via the first lead-out part 511.

During interference signals from the load circuit are conducted into the control circuit 41, they are absorbed or shielded by the anti-interference element 42, preventing disruption to the normal operation of the control circuit 41. This ensures the stability of the control circuit 41 and the reliable functioning of the relay.

In some embodiments, the first connector 51, the second connector 52, and the third connector 53 may also be mounted on the second flange 123 of the bobbin 12. Those skilled in the art can adjust the arrangement as needed, with no specific limitations imposed here.

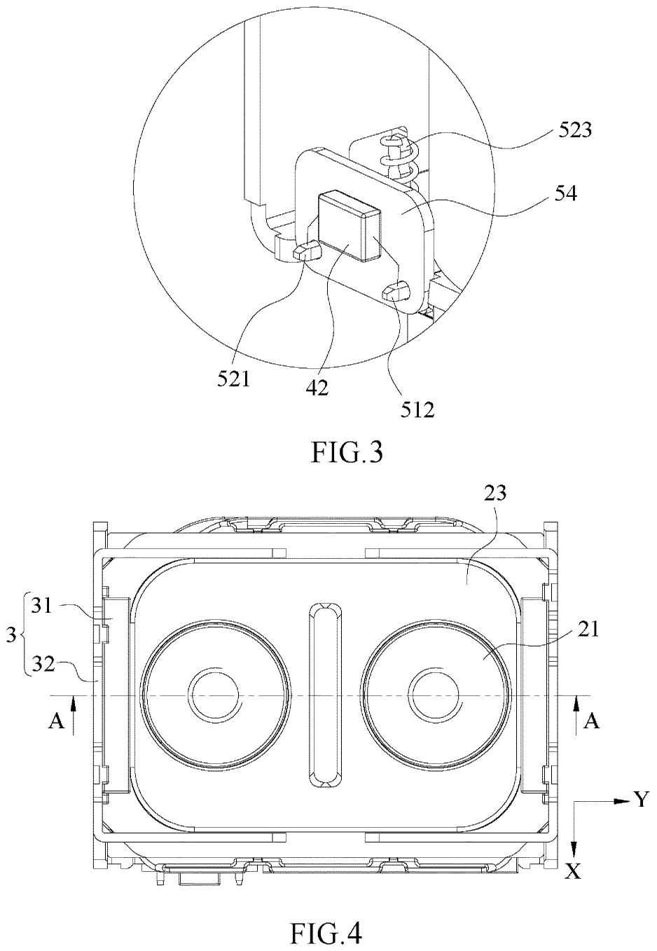

As shown in FIGS. 3, 6, and 12, the relay in the present embodiment further includes a circuit board 54 (Printed Circuit Board, PCB), with the anti-interference element 42 mounted on it. The circuit board 54 has a first through-hole 541 and a second through-hole 542. The second terminal (conductive column 512) of the first connector 51 passes through the first through-hole 541 and protrudes from the circuit board 54, while the third terminal (first connection portion 521) of the second connector 52 passes through the second through-hole 542 and protrudes from the circuit board 54.

Specifically, the anti-interference element 42 may be fixed to one surface of the circuit board 54 by soldering (e.g., tin soldering). Alternatively, the anti-interference element 42 may be secured by screws, adhesive, or other methods, with no specific limitations imposed here.

In some embodiments, the circuit board 54 is soldered to the conductive column 512 of the first connector 51 and the first connection portion 521 of the second connector 52. Since the first connector 51 and second connector 52 are fixed to the bobbin 12 (e.g., integrally molded), the circuit board 54 is thereby secured. Other fixation methods may also be used, depending on the position of the circuit board 54 and connection requirements.

Additionally, the circuit board 54 may be placed outside the housing (not shown in drawings) of the relay, such as on its outer surface, or inside the housing, with no specific limitations imposed here.

As shown in FIG. 2, the anti-interference element 42 is located on the surface of the circuit board 54 facing away from the bobbin 12, positioned between the first through-hole 541 and second through-hole 542. The first through-hole 541 corresponds to the conductive column 512 of the first connector 51, enabling it to pass through and protrude, while the second through-hole 542 corresponds to the first connection portion 521 of the second connector 52, enabling it to pass through and protrude. Thus, the anti-interference element 42 is situated between the conductive column 512 and first connection portion 521, facilitating electrical connection among the three.

By incorporating the circuit board 54, the anti-interference element 42 (or multiple such elements) can be integrated into a compact module, simplifying installation.

In some embodiments, to further ease assembly, the protrusion length of the conductive column 512 from the first flange 121 matches that of the first connection portion 521.

In some embodiments, the coil 11 has an input terminal and an output terminal. When the relay operates, the anti-interference element 42 is positioned downstream of the output terminal in the control circuit 41, meaning current flows through the coil 11 first before reaching the anti-interference element 42.

Alternatively, in other embodiments, the anti-interference element 42 may be placed upstream of input terminal of the coil 11, where current flows through the anti-interference element 42 before reaching the coil 11.

In some embodiments, there may be one or more anti-interference elements 42, such as a single magnetic bead or inductor, or a combination of both. Multiple magnetic beads and inductors may also be used, depending on the strength of interference signals in practical applications.

In summary, in the present embodiment, when the relay operates, the anti-interference element 42 is connected in series with the coil 11 in the external control circuit 41, effectively suppressing and shielding interference signals of varying frequencies conducted from the external load circuit. This prevents excessive interference from disrupting the normal operation of components in the control circuit 41, ensuring reliable relay performance. At the same time, since the anti-interference element 42 is actually connected in series with the control circuit 41, it does not directly absorb or shield signals from the external load circuit, maintaining the normal operation of the load circuit.

As shown in FIGS. 1 and 5, the relay in the present embodiment further includes an arc extinguishing unit 3, which is configured to extinguish arcs generated between the static contact leading-out terminal 21 and the movable contact piece 22. As illustrated in FIG. 5, the arc extinguishing unit 3 includes two arc extinguishing magnets 31. The arc extinguishing magnets 31 may be permanent magnets, each generally shaped as a rectangular prism. The two arc extinguishing magnets 31 are disposed on opposite sides of the insulating cover 23 along the first horizontal direction X. By arranging the two opposing arc extinguishing magnets 31, a magnetic field is formed around the static contact leading-out terminal 21 and the movable contact piece 22. Consequently, any arc generated between them will be stretched in opposite directions under the influence of the magnetic field, achieving arc extinction.

The arc extinguishing unit 3 also includes two yoke clips 32, which are positioned corresponding to the two arc extinguishing magnets 31. The yoke clips 32 encircle the insulating cover 23 and the two arc extinguishing magnets 31. This design prevents the magnetic field generated by the arc extinguishing magnets 31 from dispersing outward, thereby maintaining the arc extinguishing efficiency. The yoke clips 32 are made of soft magnetic materials, which may include but are not limited to iron, cobalt, nickel, and their alloys.

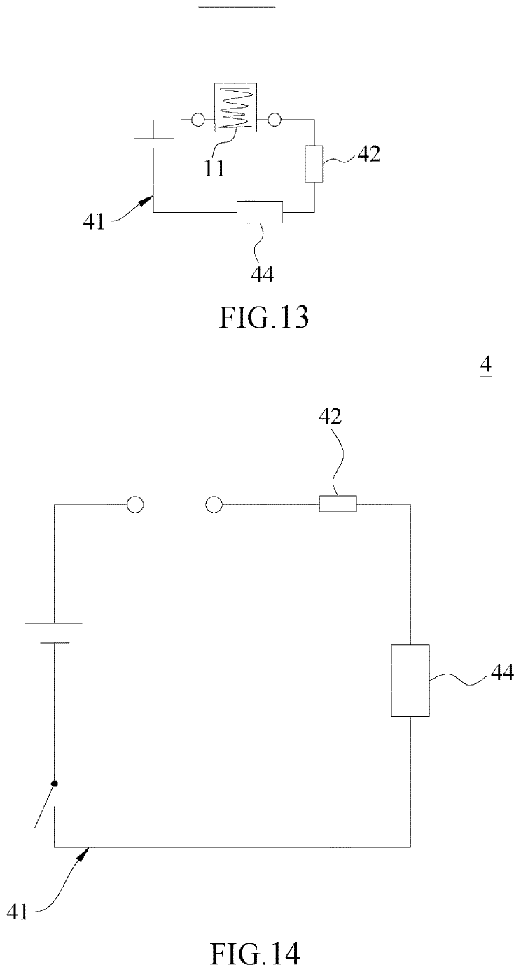

As shown in FIG. 13, the present embodiment also provides a control device, including a control circuit 41 and a relay. The relay includes a coil 11 and an anti-interference element 42, with the anti-interference element 42 connected in series with the coil 11 within the control circuit 41.

In some embodiments, the anti-interference element may be at least one of a magnetic bead and an inductor.

The relay may be any of the relays described in the preceding embodiments, and its specific structure will not be reiterated here.

As depicted in FIG. 13, the control circuit 41 includes a power supply, a resistor 44 (which may be an electronic component), a switch, and wiring, forming a current loop with the anti-interference element 42 and the coil 11 connected in series.

In the control device of the present embodiment, when the relay is in operation, the control circuit 41 is electrically connected to the relay, and the anti-interference element 42 significantly suppresses and shields interference signals conducted from the load side to the coil 11, ensuring the relay functions normally. At the same time, since the anti-interference element 42 is connected in series within the control circuit 41, it does not directly absorb or shield signals from the external load circuit, thereby maintaining the normal operation of the load circuit.

As illustrated in FIG. 14, the present embodiment further provides a control circuit module 4 for controlling electronic components. The control circuit module 4 includes a control circuit 41 and an anti-interference element 42. The control circuit 41 is configured to connect electrically with the electronic component, while the anti-interference element 42 is connected in series within the control circuit 41 and with the electronic component.

Specifically, the control circuit 41 includes a power supply, a resistor 44 (which may be an electronic component), a switch, and wiring, forming a current loop. In this embodiment, the control circuit 41 has two connection ends for connecting the electronic component in series with the anti-interference element 42 and the resistor 44. The anti-interference element 42 may be a magnetic bead and/or an inductor.

In some embodiments, the electronic component may be the relay described in any of the preceding embodiments, with the control circuit 41 connected in series with the coil 11 of the relay.

The control circuit module 41 in this embodiment is provided with the anti-interference element 42. When the control circuit 41 is connected to the electronic component, shields high and low frequency interference signals conducted from the external load circuit to the control circuit 41, ensuring the relay operates normally.

The electronic component may also be other devices susceptible to interference from external load circuits, such as contactors or circuit breakers. Applying the control circuit module of this embodiment to such devices can shield them from external interference, guaranteeing their normal operation.

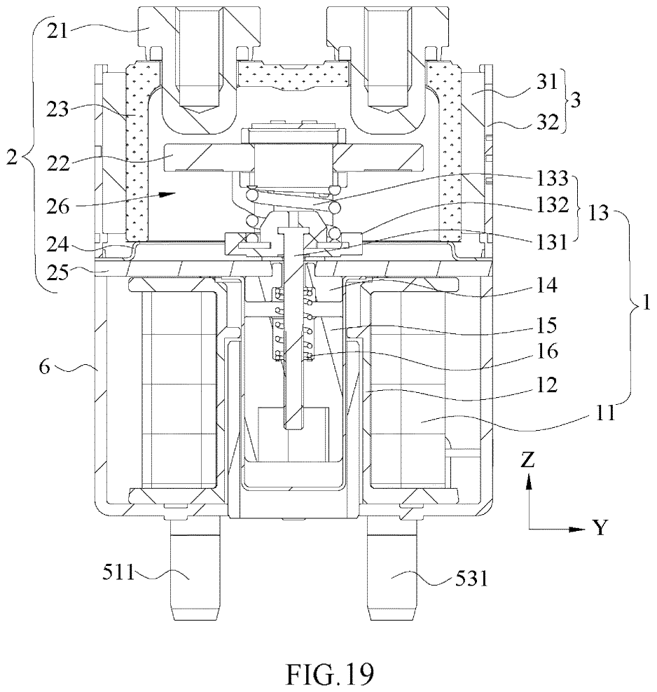

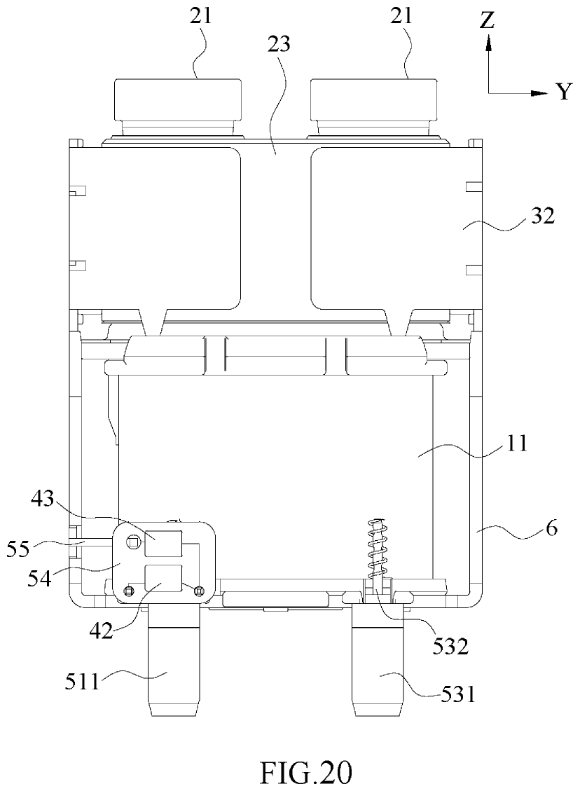

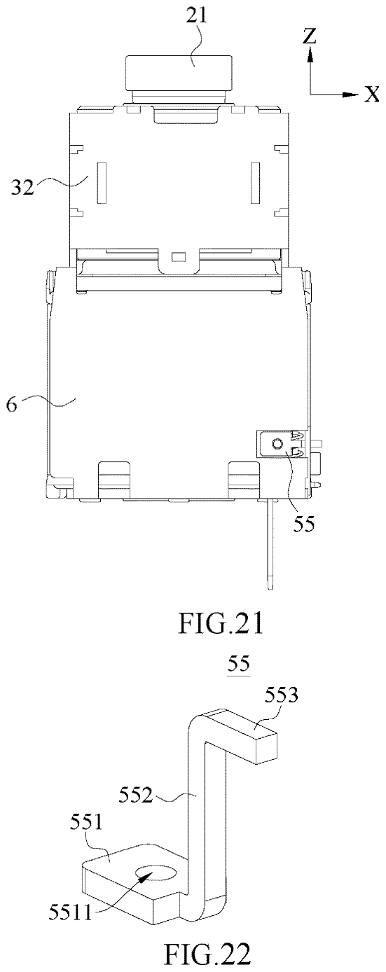

The present embodiment also provides another relay, as shown in FIGS. 16, 18-21. FIG. 16 is a perspective view of the relay (with the housing omitted), FIG. 18 is a top view of FIG. 16, FIG. 19 is a cross-sectional view along A-A in FIG. 18, FIG. 20 is a front view, and FIG. 21 is a side view.

The relay in this embodiment includes a housing (not shown), a magnetic circuit unit 1, a contact unit 2, and an arc extinguishing unit 3. As illustrated in FIGS. 18 and 19, the structures of the magnetic circuit unit 1, contact unit 2, and arc extinguishing unit 3 are the same as those described in previous embodiments and will not be repeated here.

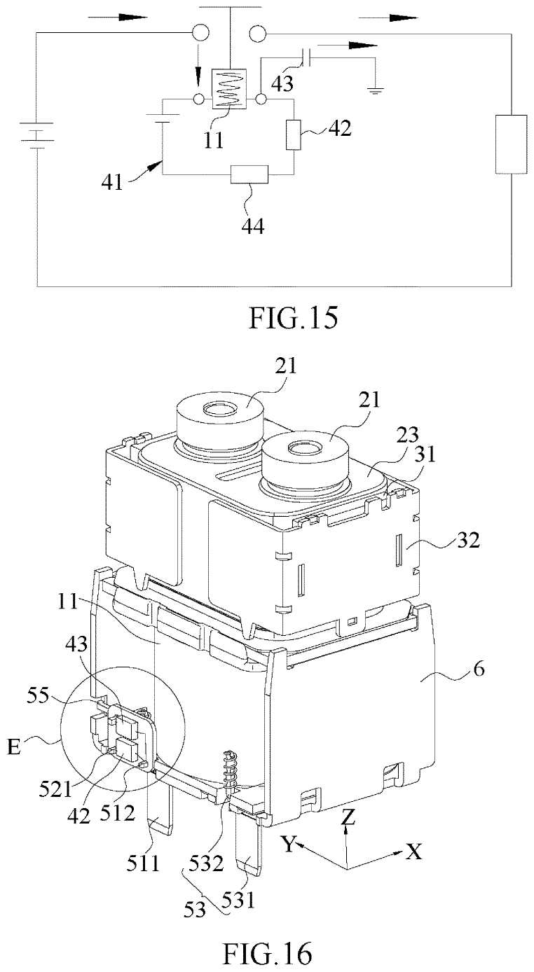

As shown in FIG. 15, the relay in this embodiment further includes an anti-interference element 42, connected in series with the coil 11 to form a series-connected assembly for electrical connection with an external control circuit 41.

As shown in FIG. 15, the external control circuit 41 includes a power supply, a resistor 44 (which may be an electronic component), a switch (not shown in FIG. 15), and wiring, forming a loop. When the relay is in operation, both ends of the coil 11 are connected to the control circuit 41, and the coil 11 is connected in series with the resistor 44. The anti-interference element 42 is connected within the control circuit 41, and is connected in series with the coil 11 and resistor 44.

In some embodiments, the anti-interference element 42 is at least one of a magnetic bead and an inductor. The magnetic bead is composed of ferrite, while the inductor consists of a magnetic core and a coil. The magnetic bead converts AC signals into heat, whereas the inductor stores AC energy and releases it gradually. The magnetic bead primarily suppresses electromagnetic radiation interference, while the inductor focuses on conductive interference. Both can suppress high-frequency noise and spike interference, mainly absorbing or shielding high-frequency interference signals.

In this embodiment, integrating the magnetic bead and/or inductor into the relay and connecting them in series with the coil 11, When the relay works, it can shield interference signals conducted from the external load circuit to the control circuit 41. Especially, it can obviously reduce and shield high-frequency interference signals transmitted from the load side to the coil 11. This prevents excessive interference from disrupting the normal operation of components in the control circuit 41, ensuring reliable relay performance. Moreover, since the anti-interference element 42 is connected in series within the control circuit 41, it does not directly absorb or shield high-frequency interference signals from the external load circuit, maintaining the normal operation of the load circuit.

As shown in FIG. 15, the relay in this embodiment also includes a capacitor 43, connected to the series-connected assembly formed by the coil 11 and anti-interference element 42. When this assembly is connected to the external control circuit 41, the capacitor 43 is not in series with the assembly.

In some embodiments, as illustrated in FIG. 15, one terminal of the capacitor 43 is connected to the series-connected assembly, while the other terminal is grounded.

Specifically, one end of the capacitor 43 may be connected between the coil 11 and the anti-interference element 42, or connected at one end of the entire series-connected assembly. When the relay is connected to the external control circuit 41, one end of the capacitor 43 only needs to be electrically linked to the control circuit 41, with no specific restrictions on the connection method.

Note that grounding the other terminal of the capacitor 43 may involve direct grounding via a wire during relay operation, or indirect grounding through conductive materials (e.g., conductive parts of the relay).

In some other embodiments, the capacitor 43 is connected in parallel with at least one of the coil 11 and the anti-interference element 42.

Specifically, the capacitor 43 may be connected in parallel with the coil 11, the anti-interference element 42, or the entire series-connected assembly formed by the coil 11 and anti-interference element 42. When the relay is electrically connected to the external control circuit 41, the capacitor 43 only needs to be linked to the control circuit 41 to achieve the aforementioned parallel connection, with no specific restrictions imposed here.

When the relay is operation, interference signals of varying frequencies from the external load circuit propagate into the control circuit 41, so that the control circuit 41 carries AC interference signals with different frequencies. Because the capacitor 43 has the characteristic of blocking DC while allowing AC to pass, these AC interference signals can be diverted through the capacitor 43, thereby providing shielding. Thus, whether one terminal of the capacitor 43 is grounded or the capacitor 43 is connected in parallel with the series assembly, interference signals can be effectively diverted.

Additionally, the frequency of the interference signals processed by the capacitor 43 is related to the specification of the capacitor 43. The specification of the capacitor 43 can be understood as the capacitance. The smaller the size of the capacitor 43, the easier it is to derive interference signals with lower frequencies. The interference signal has a frequency range, and both the capacitor 43 and anti-interference element 42 can derive or absorb the low-frequency interference signals and high-frequency interference signals, the capacitor 43 is more effective at diverting lower frequencies, and the anti-interference element 42 excels at shielding higher frequencies. The capacitor 43 and the anti-interference element 42 cooperate to shield the interference signals in all frequency ranges conducted to the coil.

The specifications of the capacitor 43 can be selected by those skilled in the art based on the interference signal frequencies, with no special limitations imposed here.

Therefore, in the embodiments of the present disclosure, when the relay operates, the anti-interference element 42 and the coil 11 are connected in series to form a series-connected assembly, which can significantly attenuate and shield high-frequency interference signals transmitted from the load side to the coil 11. Meanwhile, the capacitor 43 is connected to the series-connected assembly and is not connected to with it in series, which can effectively attenuate and shield low-frequency interference signals transmitted from the load side to the coil 11, and further can completely shield the interference signals with different frequencies, thus ensuring the normal operation of the relay.

In some embodiments, as shown in FIGS. 8 to 11, the relay further includes a first connector 51, a second connector 52, and a third connector 53, which have the same structures as described in the aforementioned embodiments and will not be repeated here. The first connector 51, second connector 52, and third connector 53 are used to connect the anti-interference element 42 and the capacitor 43 to the external control circuit 41.

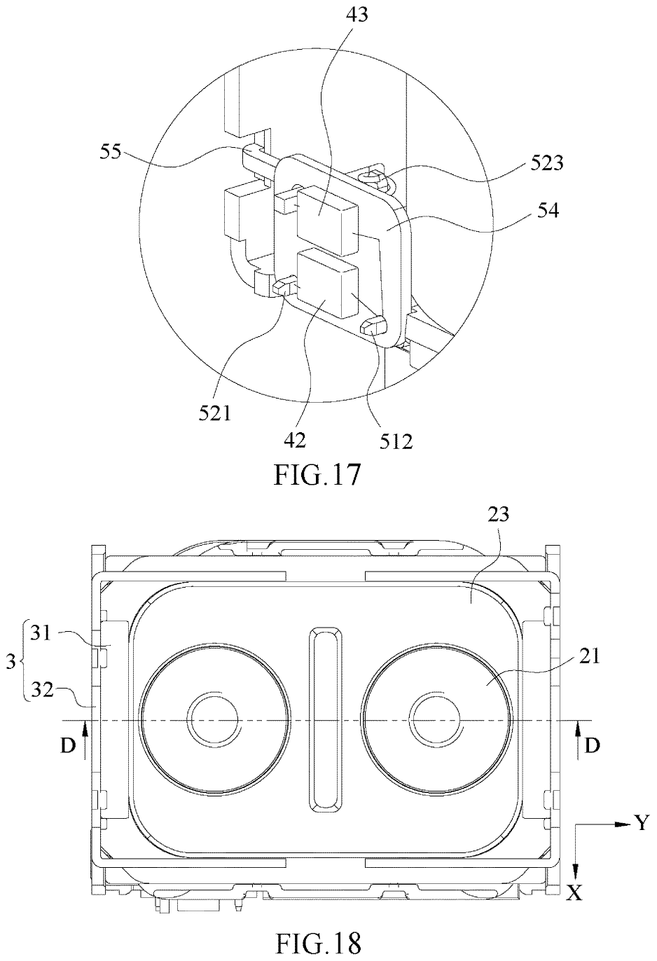

In some embodiments, as shown in FIG. 17, the second end of the first connector 51 is also connected to one end of the capacitor 43, while the other end of the capacitor 43 is grounded.

In some embodiments, one end of the capacitor 43 is connected to the conductive column 512 of the first connector 51 to establish an electrical connection between the capacitor 43 and the control circuit 41; the other end of the capacitor 43 is grounded. Alternatively, in other embodiments, one end of the capacitor 43 may also be connected to the first connection portion 521 of the second connector 52, or directly to the control circuit 41, as long as the capacitor 43 is electrically connected to the external control circuit 41 during normal operation of the relay. No specific limitations are imposed here.

Thus, as shown in FIGS. 15 to 17, when the relay is in operation, the first lead-out part 511 and the second lead-out part 531 are connected to the control circuit 41. Assuming the second lead-out part 531 is connected to the positive terminal of the power supply in the control circuit 41, for the anti-interference element 42, the current flows sequentially through the second lead-out part 531 of the third connector 53, the winding column 532, the coil 11, the third connection portion 523 of the second connector 52, the second connection portion 522, the first connection portion 521, the anti-interference element 42, and the conductive column 512 of the first connector 51, and then returning to the negative terminal of the power supply in the control circuit 41 via the first lead-out part 511 of the first connector 51. For the capacitor 43, the current flows sequentially through the second lead-out part 531 of the third connector 53, the winding column 532, the coil 11, the third connection portion 523 of the second connector 52, the second connection portion 522, the first connection portion 521 (or from the first connection portion 521 to the anti-interference element 42 and the conductive column 512), and finally the capacitor 43.

When interference signals from the load circuit are transmitted to the control circuit 41, high-frequency interference signals are absorbed or shielded after passing through the anti-interference element 42, preventing them from disrupting the normal operation of the control circuit 41. Low-frequency interference signals flow into one end of the capacitor 43 and are derived through it. As a result, both high-frequency and low-frequency interference signals are eliminated from the control circuit 41, ensuring its stability and the normal operation of the relay.

In some embodiments, the first connector 51, second connector 52, and third connector 53 may also be disposed on the second flange 123 of the bobbin 12. Those skilled in the art can adjust the arrangement based on actual requirements, with no specific limitations imposed here.

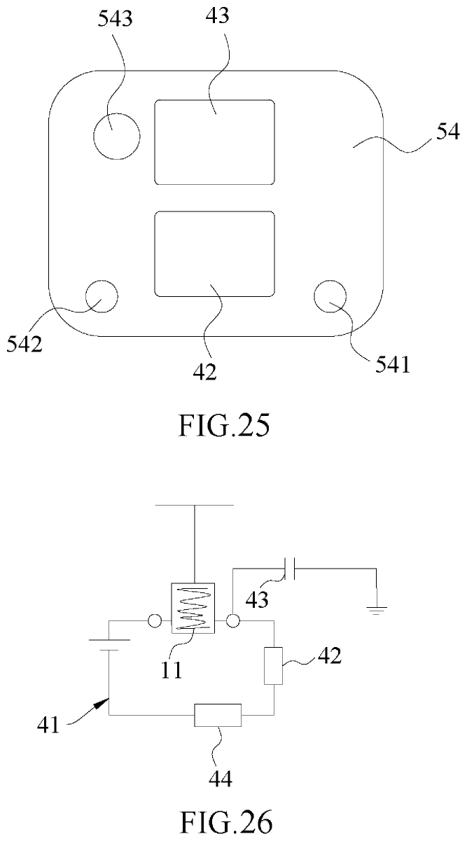

As shown in FIGS. 22 to 25, in some embodiments, the relay may further include a yoke base 6 and a lead-out member 55. The bobbin 12 is placed on the yoke base 6, and one end of the lead-out member 55 is connected to the sidewall of the yoke base 6, while the other end is connected to the other terminal of the capacitor 43. In some embodiments, the yoke base 6 at least has a first sidewall 61 and a second sidewall 62 opposite with each other and a bottom wall 63 connected to one end of the first sidewall 61 and one end of the second sidewall 62. The first sidewall 61, second sidewall 62, and bottom wall 63 form a chamber. The bobbin 12 is positioned in this chamber and placed on the bottom wall 63. One end of the lead-out member 55 is connected to the first sidewall 61 of the yoke base 6 near the capacitor 43, while the other end is connected to the other terminal of the capacitor 43. The lead-out member 55 is conductive, to derive the interference signals absorbed by the capacitor 43.

Thus, the yoke base 6, as a conductor, connects to the other terminal of the capacitor 43, grounding the capacitor 43. Additionally, as shown in FIG. 19, the yoke base 6 and the yoke plate 25 enclose a space to accommodate the magnetic circuit unit 1. When the coil 11 is energized to generate a magnetic field, the yoke base 6 prevents the magnetic field from dispersing outward, improving magnetic field utilization.

In some embodiments, as shown in FIG. 22, the lead-out member 55 includes a first lead-out portion 551, a second lead-out portion 552, and a third lead-out portion 553 connected sequentially. The first lead-out portion 551 and third lead-out portion 553 are located at opposite sides of the second lead-out portion 552, so that the lead-out member 55 is roughly Z-shaped. The lead-out member 55 may be integrally formed. The first lead-out portion 551 is used for fixed connection to the yoke base 6, while the third lead-out portion 553 is used for connection to the capacitor 43.

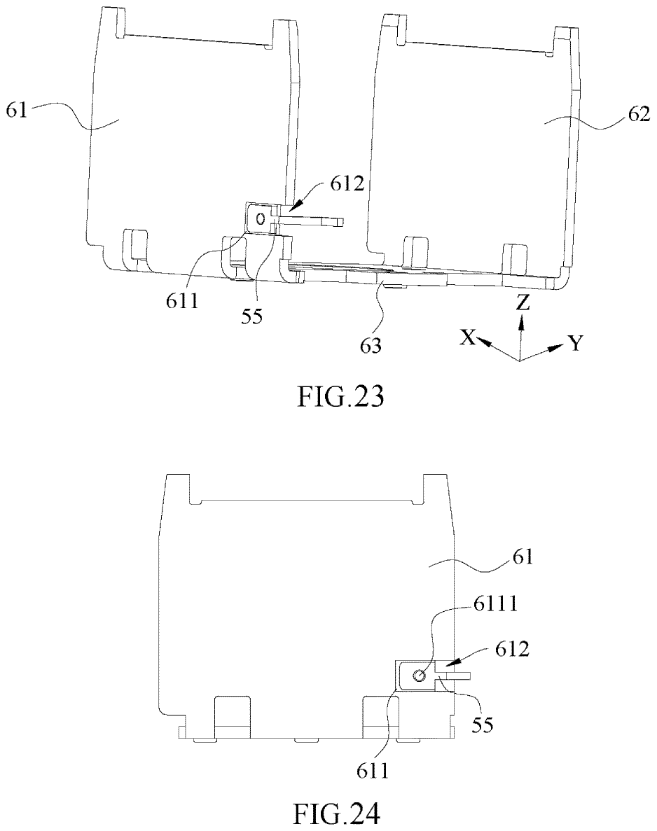

As shown in FIGS. 20 and 23, the yoke base 6 is U-shaped, with the first sidewall 61 and second sidewall 62 opposing each other along the second horizontal direction Y and extending vertically along the vertical direction Z. The first sidewall 61 is closer to the capacitor 43 compared to the second sidewall 62. The first sidewall 61 of the yoke base 6 is provided with an accommodating slot 611, and the first lead-out portion 551 is fixed within the accommodating slot 611. Specifically, as shown in FIG. 23, the side of the first sidewall 61 near the capacitor 43 is recessed to form the accommodating slot 611, which is inwardly indented from the outer surface of the first sidewall 61. The depth of the accommodating slot 611 is defined as the dimension from its opening along the second horizontal direction Y to its bottom, while the thickness of the first sidewall 61 is its dimension along the second horizontal direction Y. The depth of the accommodating slot 611 is less than the thickness of the first sidewall 61, meaning that the slot does not penetrate the sidewall. The bottom of the accommodating slot 611 faces its opening and constitutes the remaining portion of the first sidewall 61 after the slot is formed. Additionally, the edge of the first sidewall 61 corresponding to the accommodating slot 611 is provided with a notch 612, which connects with the accommodating slot 611 along the second horizontal direction Y.

As shown in FIG. 22, the first lead-out portion 551 may include a riveting hole 5511. FIG. 24 shows that the bottom of the accommodating slot 611 has a riveting protrusion 6111. The first lead-out portion 551 is placed in the accommodating slot 611 and riveted to the first sidewall 61 of the yoke base 6 via the engagement of the riveting hole 5511 and the riveting protrusion 6111. In some embodiments, the first lead-out portion 551 and third lead-out portion 553 are perpendicular to the second lead-out portion 552, respectively. The notch 612 gives way for the second lead-out portion 552, making the structure of the relay more compact and reducing its overall size. Furthermore, the third lead-out portion 553 of the lead-out member 55 connects to the capacitor 43, allowing interference signals absorbed by the capacitor 43 to be conducted to the yoke base 6, thereby grounding the other terminal of the capacitor 43.

As shown in FIGS. 17, 20, and 25, the relay in this embodiment also includes a circuit board 54 (abbreviated as PCB), with the anti-interference element 42 and capacitor 43 mounted on it. The circuit board 54 has a first through-hole 541, a second through-hole 542, and a third through-hole 543. The second end (conductive column 512) of the first connector 51 passes through the first through-hole 541 and extends out of the circuit board 54; the third end (connection portion 521) of the second connector 52 passes through the second through-hole 542 and extends out of the circuit board 54; and the third lead-out portion 553 of the lead-out member 55 passes through the third through-hole 543 and extends out of the circuit board 54.

Specifically, the capacitor 43 and anti-interference element 42 can be fixed on the same surface of the circuit board 54 by soldering (e.g., tin soldering). Alternatively, they may be secured via screw fastening, adhesive bonding, or other methods, with no specific limitations imposed here.

In some embodiments, the circuit board 54 is soldered to the conductive column 512 of the first connector 51, the first connection portion 521 of the second connector 52, and the third lead-out portion 553 of the lead-out member 55. The first connector 51 and the second connector 52 are fixed to the bobbin 12 (e.g., integrally molded), while the first lead-out portion 551 of the lead-out member 55 is riveted to a sidewall of the yoke base 6, thereby securing the circuit board 54. In other embodiments, the circuit board 54 may be fixed to the yoke base 6 via soldering, riveting, screw fastening, etc. The mounting method can be adjusted based on the position of the circuit board 54 and connection requirements, with no strict constraints. Additionally, the circuit board 54 may be placed externally (e.g., on the housing surface) or internally within the housing of the relay, with no specific limitations.

As shown in FIG. 16, the anti-interference element 42 and capacitor 43 are located on the surface of the circuit board 54 opposite to the bobbin 12, with the anti-interference element 42 positioned between the first through-hole 541 and the second through-hole 542. The first through-hole 541 corresponds to the conductive column 512 of the first connector 51, enabling it to pass through and protrude; the second through-hole 542 corresponds to the first connection portion 521 of the second connector 52, enabling it to pass through and protrude. Thus, the anti-interference element 42 is positioned between the conductive column 512 and the first connection portion 521, facilitating their electrical connection. The third through-hole 543 corresponds to the third lead-out portion 553 of the third connector 53, enabling it to pass through and protrude, while the capacitor 43 is placed near the third through-hole 543 for easy connection to the third lead-out portion 553.

By incorporating the circuit board 54, the anti-interference element 42 and capacitor 43 can be integrated into a compact module, simplifying installation.

In some embodiments, to further ease assembly, the protruding length of the conductive column 512 from the first flange 121 matches that of the first connection portion 521 of the second connector 52.

In some embodiments, the coil 11 has an input terminal and an output terminal. During operation, the anti-interference element 42 and capacitor 43 are positioned downstream of the output terminal in the control circuit 41, meaning current flows through the coil 11 before reaching them. Alternatively, they may be placed upstream of the input terminal, allowing current to pass through them before entering the coil 11.

In some embodiments, one anti-interference element 42 and one or more capacitors 43 are used. In others, multiple anti-interference elements 42 and one or more capacitors 43 may be employed. The anti-interference element 42 can be a magnetic bead, an inductor, or a combination of both, with quantities adjustable based on interference signal strength. No strict limitations are imposed.

Research shows that for interference signals within a specific frequency range, magnetic beads/inductors primarily attenuate high-frequency components, while capacitors 43 attenuate low-frequency components. The smaller the specification of the capacitor 43, the easier it is to derive the interference signal with lower frequency, and the smaller the specification of the capacitor 43, the smaller the frequency range of the interference signal that can be derived by the capacitor 43. Therefore, the number of anti-interference elements 42 and capacitors 43 can be considered according to the frequency range of interference signals and the specifications of capacitors 43. The number of anti-interference elements 42 can be one or more, and the number of capacitors 43 can also be one or more. Those skilled in the art can set them according to the actual situation, and there is no special limitation here.

In summary, when the relay is in operation, the anti-interference element 42 and coil 11 form a series-connected assembly, which significantly attenuates and shields high-frequency interference from the load side to the control circuit 41, especially the higher frequency interference signal among the interference signals conducted from the load end to the coil 11, avoiding the influence of the received interference signal in the control circuit 41 on the normal operation of components in the control circuit 41, and ensuring the normal use of the relay. At the same time, when the relay is in operation, the anti-interference element 42 is actually connected in series with the control circuit 41, so as not to directly absorb or shield the signals in the external load circuit, and ensure the normal operation of the external load circuit. The capacitor 43 is connected to the series-connected assembly and not connected in series to the series-connected assembly, which can obviously reduce and shield the low-frequency interference signal among the interference signals input from the load terminal and conducted to the coil 11, so as to completely shield the interference signal and ensure the normal operation of the relay.

As shown in FIG. 26, this embodiment also provides a control device, including a control circuit 41 and the aforementioned relay. The relay includes the coil 11, the anti-interference element 42, and the capacitor 43. The anti-interference element 42 is connected in series with the coil 11, forming the series-connected assembly. The series-connected assembly is connected to the control circuit 41. The capacitor 43 is connected to the series-connected assembly, and the capacitor 43 and the series-connected assembly are not connected in series.

The relay may be any of the relays in the above embodiments, and its specific structure will not be repeated here.

As shown in FIG. 26, the control circuit 41 has a power supply, a resistor 44 (which may be an electronic component), a switch, and wires. The series-connected assembly is connected to the control circuit 41 to form a current loop. In some embodiments, one end of the capacitor 43 is connected to the control circuit 41, and the other end is grounded. In other embodiments, the capacitor 43 is connected in parallel to the control circuit 41, that is, the capacitor 43 is connected in parallel with at least one of the anti-interference elements 42, the coil 11, and the resistor 44.

In the control device of the embodiments of the present disclosure, when the relay is in operation, the control circuit 41 is electrically connected to the relay, and the anti-interference element 42 can significantly reduce and shield the high-frequency interference signals transmitted from the load end to the coil 11, ensuring the normal use of the relay. At the same time, the anti-interference element 42 is connected in series in the control circuit 41 and does not directly absorb or shield the signals in the external load circuit, ensuring the normal operation of the external load circuit. By connecting the capacitor 43 to the series-connected assembly and not connecting it in series with the series-connected assembly, the low-frequency interference signals input from the load end and transmitted to the coil 11 can be significantly reduced and shielded, thereby comprehensively shielding interference signals of different frequencies and ensuring the normal operation of the relay.

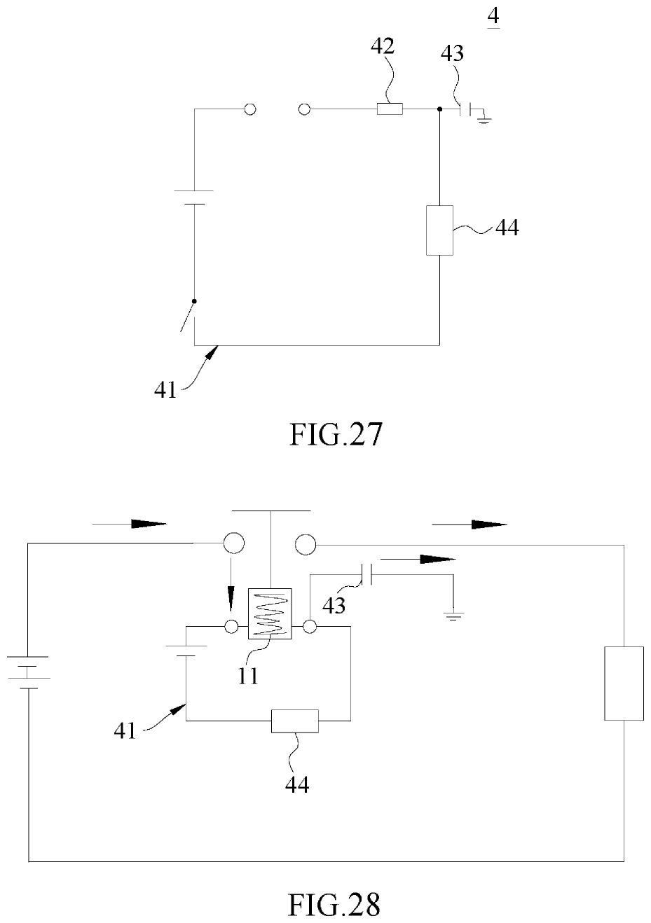

As shown in FIG. 27, the embodiments of the present disclosure also provide a control circuit module 4 for controlling an electronic device. The control circuit module 4 includes a control circuit 41, an anti-interference element 42, and a capacitor 43. Among them, the control circuit 41 is used to electrically connect to the electronic device. The anti-interference element 42 is electrically connected to the control circuit 41 and used to connect in series with the electronic device. The capacitor 43 is electrically connected to the control circuit 41, and when the control circuit 41 is electrically connected to the electronic device, the capacitor 43 is not connected in series with the electronic device and the anti-interference element 42.

Specifically, the control circuit 41 has a power supply, a resistor 44 (which may be an electronic component), a switch, and wires, and can form a current loop. In the embodiments of the present disclosure, the control circuit 41 has two connection ends for connecting the electronic device to the control circuit 41, connecting in series with the anti-interference element 42 and the resistor 44 mentioned above. One end of the capacitor 43 can connected to any point in the control circuit 41, while the other end of the capacitor 43 is grounded, or the capacitor 43 is connected in parallel with at least one of the anti-interference elements 42 and the resistor 44, or when the control circuit 41 is electrically connected to the electronic component, the capacitor 43 is connected in parallel with the electronic component. Wherein the anti-interference element 42 may be a magnetic bead and/or an inductor.

In some embodiments, the electronic device may be the relay in any of the above embodiments, and the control circuit 41 is used to connect in series with the coil 11 of the relay.

The control circuit module 41 in the embodiments of the present disclosure is provided with the anti-interference element 42 and the capacitor 43. After the control circuit 41 is connected to the electronic device, it can comprehensively shield high-frequency interference and low-frequency interference signals transmitted from the external load circuit to the control circuit 41, ensuring the normal operation of the relay.

The electronic device may also be other components affected by interference signals from the external load circuit, such as contactors, circuit breakers, etc. Applying the control circuit module of the embodiments of the present disclosure to the electronic device can shield the influence of external interference signals on the electronic device and ensure the normal operation of the electronic device.

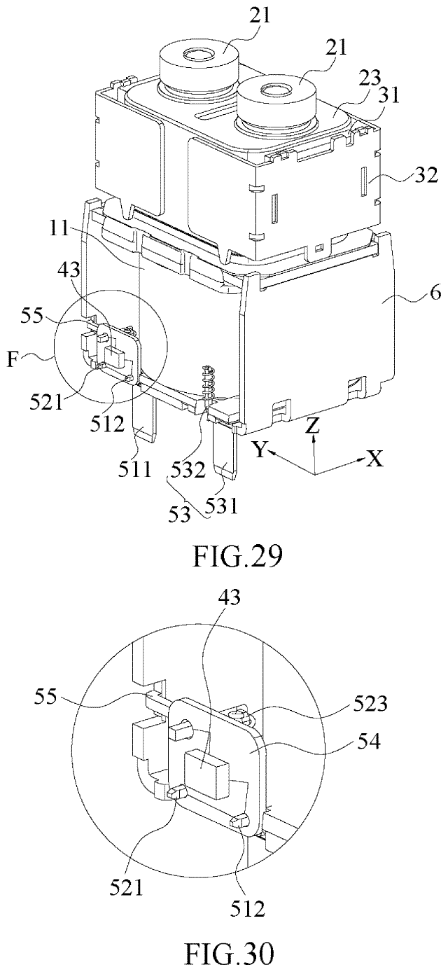

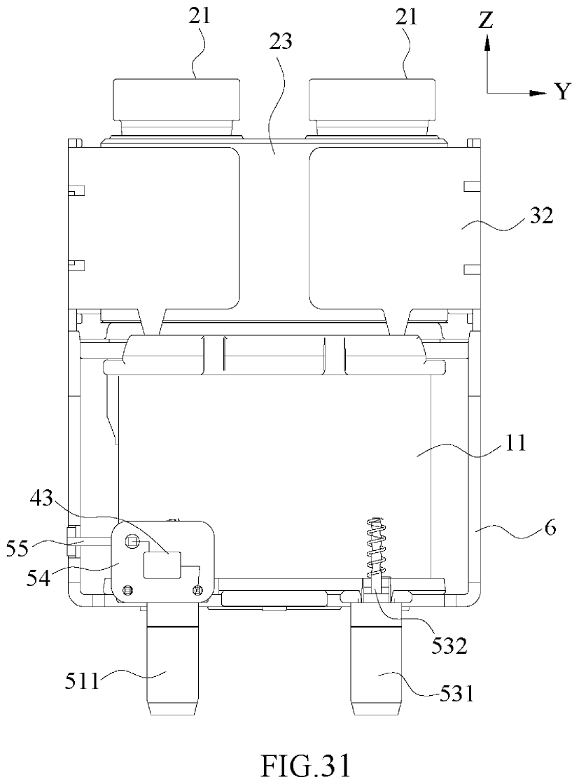

The embodiments of the present disclosure also provide a relay, as shown in FIGS. 29, 31, 18 to 19, and 21, where FIG. 29 shows a three-dimensional schematic diagram of the relay of the embodiments of the present disclosure, with the housing omitted. FIG. 18 shows a top view of FIG. 29, FIG. 19 shows a cross-sectional view along D-D in FIG. 18, FIG. 31 shows a front view of the relay, and FIG. 21 shows a side view of the relay.

The relay of the embodiments of the present disclosure includes a housing (not shown in the drawings, a magnetic circuit unit 1, a contact unit 2, and an arc extinguishing unit 3. As shown in FIGS. 18 and 19, the magnetic circuit unit 1, contact unit 2, and arc extinguishing unit 3 are the same as those described in some of the above embodiments, and will not be repeated here.

As shown in FIG. 28, the relay of the embodiments of the present disclosure also includes a capacitor 43 connected to the coil 11. When the coil 11 is electrically connected to the external control circuit 41, that is, when the relay is in the operation state, the capacitor 43 is not connected in series with the coil.

As shown in FIG. 28, the external control circuit 41 includes a power supply, a resistor 44 (which may be an electronic device), a switch (not shown in FIG. 28), and wires to form a loop. When the relay is in the operation state, both ends of the coil 11 are connected to the external control circuit 41, so that the coil 11 is connected in series with the resistor 44. The capacitor 43 is connected to the coil 11, so that the capacitor 43 and the coil 11 are not connected in series in the control circuit 41.

In some embodiments, as shown in FIG. 28, one end of the capacitor 43 is connected to the coil 11, and the other end is grounded.

Specifically, as shown in FIG. 28, one end of the capacitor 43 may be connected to one end of the coil 11. When the relay is electrically connected to the external control circuit 41, as long as one end of the capacitor 43 can be electrically connected to the control circuit 41, there are no special restrictions here.

It should be noted that grounding the other end of the capacitor 43 may mean that when the relay is in operation, the other end of the capacitor 43 is directly grounded through wires, or the other end of the capacitor 43 is connected to other conductors, such as conductive materials of the relay, and grounded through the conductor.

In other embodiments, the capacitor 43 is connected in parallel with the coil 11. When the relay is electrically connected to the external control circuit 41, the capacitor 43 can be connected to the control circuit and connected in parallel with the coil 11.

When the relay is in the operation state, interference signals of different frequencies from the external load circuit will propagate to the control circuit 41, causing the control circuit 41 to carry AC interference signals of different frequencies. Since the capacitor 43 has the characteristic of blocking DC and passing AC, these AC interference signals can be derived through the capacitor 43, thus playing a shielding role. Therefore, whether one end of the capacitor 43 is grounded or the capacitor 43 is connected in parallel with the coil 11, the interference signals can be derived.

In addition, the frequency range of the interference signals derived by the capacitor 43 is related to the specifications of the capacitor 43. The specifications of the capacitor 43 can be understood as the capacitance. The smaller the specifications of the capacitor 43, the easier it is to derive lower-frequency interference signals; the larger the specifications, the easier it is to derive higher-frequency interference signals, and the larger the specifications, the wider the frequency range of interference signals that the capacitor 43 can derive. In the embodiments of the present disclosure, capacitors with appropriate specifications can be selected according to the frequency range of the interference signals, so as to derive the interference signals transmitted from the load circuit, thereby significantly reducing and shielding interference signals of different frequencies. At the same time, when the relay is in operation, the capacitor 43 is actually electrically connected to the control circuit 41, so it does not directly absorb or shield signals in the external load circuit, ensuring the normal operation of the load circuit.

In some embodiments, as shown in FIGS. 8 to 11, the relay also includes a first connector 51, a second connector 52, and a third connector 53, which have the same structures as the first connector 51, the second connector 52, and the third connector 53 described in the above embodiments, and will not be repeated here. The first connector 51, the second connector 52, and the third connector 53 are used to connect the capacitor 43 to the coil 11.

As shown in FIGS. 8 to 10, the first connector 51 is conductive and arranged on the bobbin 12. The first connector 51 has a first end and a second end. The first end is used to connect to one pole of the power supply of the external control circuit 41, and the second end is used to connect to one end of the capacitor 43. The second connector 52 is conductive and arranged on the bobbin 12. The second connector 52 has a third end and a fourth end. The third end is connected to the second end of the first connector 51, and the fourth end is connected to one end of the coil 11. The other end of the coil 11 is used to connect to the other pole of the power supply of the external control circuit 41, so that when the coil 11 is electrically connected to the external control circuit 41, a loop is formed.

In some embodiments, as shown in FIG. 10, the first lead-out part 511 is plate-shaped for connection with the control circuit 41. The conductive column 512 is located at one end of the first lead-out part 511 and perpendicular to it. The conductive column 512 and first lead-out part 511 may be integrally formed. The conductive column 512 is used for electrical connection with one terminal of the capacitor 43. In some embodiments, the width of the conductive column 512 is smaller than that of the first lead-out part 511. Referring to FIG. 9, the width of the conductive column 512 refers to its dimension along the second horizontal direction Y, while the width of the first lead-out part 511 refers to its dimension along the same direction. Setting the conductive column 512 narrower than the first lead-out part 511 facilitates wiring and saves space/material. The portion of the first lead-out part 511 extending out of the first flange 121 serves as the first end of the first connector 51 for connecting to the control circuit 41, while the portion of the conductive column 512 extending out of the first flange 121 serves as the second end of the first connector 51 for connecting to one terminal of the capacitor 43.

In some embodiments, as shown in FIG. 30, the second end of the first connector 51 connects to one end of the capacitor 43, with the other end grounded.

In some embodiments, one end of the capacitor 43 connects to the conductive column 512 of the first connector 51 to achieve electrical connection with the control circuit 41; the other end is grounded. Alternatively, the capacitor 43 may connect to the first connection portion 521 of the second connector 52 or directly to the control circuit 41, as long as one end of the capacitor 43 is electrically connected to the external control circuit 41 when the relay operates normally, and there is no special limitation.

Thus, as shown in FIGS. 28 to 30, when the relay is in operation, the first lead-out part 511 and the second lead-out part 531 are connected to the control circuit 41. Assuming the second lead-out part 531 is connected to the positive terminal of the power supply in the control circuit 41, the current flows sequentially through the second lead-out part 531 of the third connector 53, the winding column 532, the coil 11, the third connection portion 523 of the second connector 52, the second connection portion 522, the first connection portion 521, the conductive column 512 of the first connector 51, and then returns to the negative terminal of the power supply in the control circuit 41 via the first lead-out part 511 of the first connector 51. For the capacitor 43, the current flows sequentially through the second lead-out part 531 of the third connector 53, the winding column 532, the coil 11, the third connection portion 523 of the second connector 52, the second connection portion 522, the first connection portion 521 (or flows from the first connection portion 521 to the conductive column 512 of the first connector 51), and the capacitor 43.

When interference signals from the load circuit are conducted into the control circuit 41, the interference signals flow into one end of the capacitor 43 and are derived through the capacitor 43. Therefore, interference signals of different frequencies can be eliminated from the control circuit 41, ensuring the stability of the control circuit 41 and the normal operation of the relay.

In some embodiments, the first connector 51, the second connector 52, and the third connector 53 may also be arranged on the second flange 123 of the bobbin 12. Those skilled in the art can configure this according to actual conditions, and no special limitations are imposed here.

As shown in FIGS. 22 to 24, in some embodiments, the relay may further include a yoke base 6 and a lead-out member 55. The bobbin 12 is placed on the yoke base 6, with one end of the lead-out member connected to the sidewall of the yoke base 6 and the other end connected to the other end of the capacitor 43 to derive the interference signals absorbed by the capacitor 43. The structure and function of the yoke base 6 and the lead-out member 55 are the same as those in the above embodiments and will not be repeated here.

Therefore, the yoke base 6 serves as a conductor and is connected to the other end of the capacitor 43 to achieve grounding of the capacitor 43. Additionally, as shown in FIG. 19, the yoke base 6 and the yoke plate 25 enclose a space to accommodate the magnetic circuit unit 1. When the coil 11 is energized and generates a magnetic field, the yoke base 6 can prevent the magnetic field from dispersing outward, improving the utilization efficiency of the magnetic field.

In some embodiments, as shown in FIG. 12, the lead-out member 55 has a first lead-out portion 551, a second lead-out portion 552, and a third lead-out portion 553 connected in sequence. The first lead-out portion 551 and the third lead-out portion 553 are located at opposite sides of the second lead-out portion 552, making the lead-out member 55 roughly Z-shaped. The lead-out member 55 may be integrally formed. The first lead-out portion 551 is used for fixed connection with the yoke base 6, and the third lead-out portion 553 is used for connection with the capacitor 43. In some embodiments, the third lead-out portion 553 of the lead-out member 55 is connected to the capacitor 43 to conduct the interference signals flowing through the capacitor to the yoke base 6, thereby grounding the other end of the capacitor 43.

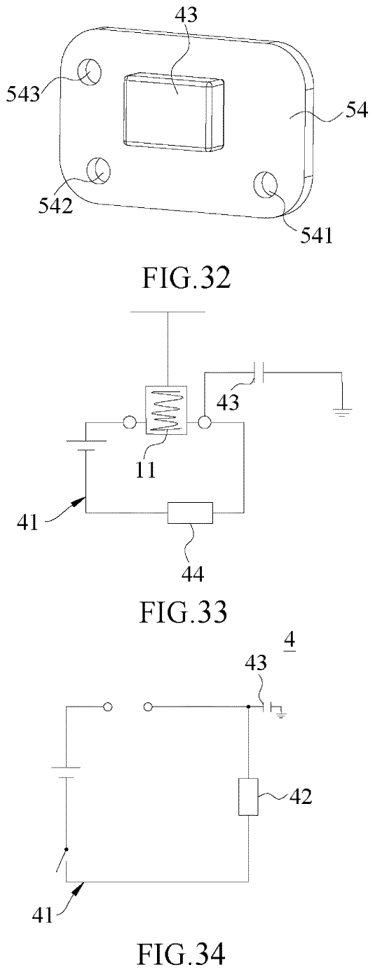

As shown in FIGS. 30, 31, and 32, the relay in the embodiments of this disclosure further includes a circuit board 54 (abbreviated as PCB), with the capacitor 43 mounted on the circuit board 54. The circuit board 54 has a first through-hole 541, a second through-hole 542, and a third through-hole 543. The second end (conductive column 512) of the first connector 51 passes through the first through-hole 541 and extends out of the circuit board 54. The third end (connection portion 521) of the second connector 52 passes through the second through-hole 542 and extends out of the circuit board 54. The third lead-out portion 553 of the lead-out member 55 passes through the third through-hole 543 and extends out of the circuit board 54.

Specifically, the capacitor 43 can be fixed on the same surface of the circuit board 54 by soldering, such as tin soldering. Of course, the capacitor 43 can also be fixed by other connection methods such as screwing or adhesive bonding, and no special limitations are imposed here.

In some embodiments, the circuit board 54 is soldered to the conductive column 512 of the first connector 51, the first connection portion 521 of the second connector 52, and the third lead-out portion 553 of the lead-out member 55. The first connector 51 and the second connector 52 are fixed to the bobbin 12 (e.g., integrally formed with the bobbin 12). The first lead-out portion 551 of the lead-out member 55 is riveted to a sidewall of the yoke base 6, thereby securing the circuit board 54. In other embodiments, the circuit board 54 can be fixed to the yoke base 6 by soldering, riveting, screwing, or other connection methods. Of course, the circuit board 54 can also be fixed by other means, and those skilled in the art can configure this based on the position and connection relationship of the circuit board 54, with no special limitations imposed here. Additionally, the circuit board 54 can be arranged outside the housing of the relay (not shown in the drawings), such as on the outer surface of the housing, or inside the housing, with no special limitations imposed here.

As shown in FIG. 29, the capacitor 43 is located on the surface of the circuit board 54 away from the bobbin 12. The first through-hole 541 of the circuit board 54 corresponds to the conductive column 512 of the first connector 51, allowing the conductive column 512 to pass through and extend out of the first through-hole 541. The second through-hole 542 corresponds to the first connection portion 521 of the second connector 52, allowing the first connection portion 521 to pass through and extend out of the second through-hole 542. The third through-hole 543 corresponds to the third lead-out portion 553 of the third connector 53, allowing the third lead-out portion 553 to pass through and extend out of the third through-hole 543. The capacitor 43 is located between the first through-hole 541 and the third through-hole 543, facilitating connection to both the conductive column 512 of the first connector 51 and the third lead-out portion 553 of the lead-out member 55.

By incorporating the circuit board 54, the capacitor 43 can be integrated into a single module (e.g., when multiple capacitors 43 are used), achieving a compact structure and simplified installation.

In some embodiments, to further facilitate installation, the extension dimension of the conductive column 512 of the first connector 51 protruding from the first flange 121 is the same as the extension dimension of the first connection portion 521 of the second connector 52 protruding from the first flange 121.

In some embodiments, the coil 11 has an input terminal and an output terminal. During the operation of the relay, the capacitor 43 is located downstream of the output terminal in the control circuit 41. That is, the current in the control circuit 41 first flows through the coil 11, and then is diverted to flow through the capacitor 43.

Of course, in other embodiments, the capacitor 43 in the control circuit 41 may also be located upstream of the input terminal of the coil 11. That is, the current in the control circuit 41 is first diverted through the capacitor 43 then flowing through the coil 11.

In some embodiments, the number of capacitors 43 may be one or multiple. Those skilled in the art may select based on the frequency range of interference signals in actual conditions, with no special limitations imposed here.

In summary, in the embodiments of this disclosure, when the relay operates, the coil 11 is connected to the external control circuit 41, and the capacitor 43 is also electrically connected to the control circuit 41 and is not connected in series with the coil 11. The capacitor 43 can significantly attenuate and shield interference signals of different frequencies, ensuring the stability of the external control circuit 41 and the normal operation of the relay. At the same time, when the relay operates, the capacitor 43 is effectively connected to the control circuit 41 and thus does not directly absorb or shield signals from the external load circuit, ensuring the normal operation of the load circuit.

As shown in FIG. 33, an embodiment of this disclosure also provides a control device, including a control circuit 41 and a relay. The relay includes a coil 11 and a capacitor 43. The coil 11 is electrically connected to the control circuit 41, and the capacitor 43 is connected to the coil 11 but not in series with it in the control circuit 41.

The relay may be the relay from any of the above embodiments, and its specific structure will not be repeated here.

As shown in FIG. 33, the control circuit 41 includes a power supply, a resistor 44 (which may be an electronic component), a switch, and wiring. The coil 11 is connected in series with the resistor 42 in the control circuit 41 to form a current loop. In some embodiments, one end of the capacitor 43 is connected to the control circuit 41, and the other end is grounded. In other embodiments, the capacitor 43 is connected in parallel in the control circuit 41, i.e., the capacitor 43 is connected in parallel with at least one of the coil 11 and the resistor 42.

In the control device of this embodiment, the control circuit 41 is electrically connected to the relay, and the capacitor 43 can significantly attenuate and shield interference signals of different frequencies, ensuring the stability of the control circuit 41 and the normal operation of the relay. At the same time, when the relay operates, the capacitor 43 is effectively connected to the control circuit 41 and thus does not directly absorb or shield signals from the external load circuit, ensuring the normal operation of the load circuit.

As shown in FIG. 34, an embodiment of this disclosure also provides a control circuit module 4 for controlling an electronic component. The control circuit module 4 includes a control circuit 41 and a capacitor 43. The control circuit 41 is used for electrical connection with the electronic component. The capacitor 43 is electrically connected to the control circuit 41, and when the control circuit 41 is connected to the electronic component, the capacitor 43 is not connected in series with the electronic component.

Specifically, the control circuit 41 includes a power supply, a resistor 44 (which may be an electronic component), a switch, and wiring, forming a current loop. In this embodiment, the control circuit 41 has two connection ends for connecting the electronic component to the control circuit 41 in series with the resistor 42. One end of the capacitor 43 may be connected any point in the control circuit 41, while the other end is grounded. Alternatively, the capacitor 43 may be connected in parallel with the resistor 42, or when the control circuit 41 is connected to the electronic component, the capacitor 43 may be connected in parallel with the electronic component, with no special limitations imposed here.

In some embodiments, the electronic component may be the relay from any of the above embodiments, and the control circuit 41 is used for series connection with the coil 11 of the relay.

The control circuit module 41 in this embodiment includes a capacitor 43. When the control circuit 41 is connected to the electronic component, it can shield interference signals of different frequencies conducted from the external load circuit to the control circuit 41, ensuring the normal operation of the relay.

The electronic component may also be other components affected by interference signals from external load circuits, such as contactors or circuit breakers. Applying the control circuit module of this embodiment to such electronic components can shield them from external interference signals, ensuring their normal operation.

It is understood that the various embodiments/implementations provided in this invention can be combined without conflict, and examples will not be listed exhaustively here.

In the embodiments of this invention, the terms “first,” “second,” and “third” are used for descriptive purposes only and should not be construed as indicating or implying relative importance. The term “multiple” refers to two or more unless explicitly limited otherwise. Terms such as “mount,” “connect,” “couple,” and “fix” should be interpreted broadly. For example, “connect” may refer to a fixed connection, a detachable connection, or an integral connection; “couple” may refer to a direct connection or an indirect connection through an intermediary. Those skilled in the art can interpret the specific meanings of these terms in the embodiments of this invention based on the context.

In the description of the embodiments of this invention, it should be understood that directional or positional terms such as “upper,” “lower,” “left,” “right,” “front,” and “rear” are based on the orientations or positional relationships shown in the drawings. These terms are used only to simplify the description of the embodiments and do not imply that the described device or unit must have a specific orientation or be constructed and operated in a specific direction. Therefore, they should not be construed as limiting the embodiments of this invention.

In the description of this specification, terms such as “one embodiment,” “some embodiments,” or “specific embodiments” mean that the specific features, structures, materials, or characteristics described in connection with the embodiment or example are included in at least one embodiment or example of this invention. In this specification, schematic references to these terms do not necessarily refer to the same embodiment or example. Furthermore, the described specific features, structures, materials, or characteristics may be combined in any suitable manner in one or more embodiments or examples.

The above are only preferred embodiments of this invention and are not intended to limit it. For those skilled in the art, various modifications and variations can be made to this invention. Any modifications, equivalent substitutions, or improvements made within the spirit and principles of this invention shall be included within the scope of protection of this invention.

1-14. (canceled)

15. A relay, comprising:
a coil configured to electrically connect to an external control circuit; and
a capacitor connected to the coil, wherein when the coil is configured to electrically connect to the external control circuit, the capacitor is not connected in series with the coil.

16. The relay according to claim 15, wherein one end of the capacitor is connected to the coil, and another end is grounded.

17. The relay according to claim 15, wherein the capacitor is connected in parallel with the coil.

18. The relay according to claim 15, further comprising:
a bobbin wound around the bobbin;
a first connector having conductivity and disposed on the bobbin, wherein the first connector has a first end and a second end, the first end is configured to connect to one pole of a power supply of an external control circuit, and the second end is connected to one end of the capacitor;
a second connector having conductivity and disposed on the bobbin, wherein the second connector has a third end and a fourth end, the third end is connected to the second end of the first connector, and the fourth end is connected to one end of the coil;
wherein another end of the coil is configured to connect to another pole of the power supply of the external control circuit, such that the coil forms a loop when electrically connected to the external control circuit.

19. The relay according to claim 18, further comprising:
a third connector having conductivity and disposed on the bobbin, wherein the third connector has a fifth end and a sixth end, the fifth end is connected to another end of the coil, and the sixth end is configured to connect to another pole of the power supply of the external control circuit.

20. The relay according to claim 18, wherein the bobbin comprises a winding part, a first flange and a second flange, the first flange and the second flange are located at two sides of the winding part and protruding outward; the first connector has a first lead-out part and a conductive column, the conductive column is vertically connected to one end of the first lead-out part, a portion of the first connector is embedded in the first flange, the first lead-out part extends along a vertical direction and protrudes from a bottom of the first flange, the conductive column extends along a first horizontal direction and protrudes from a side of the first flange; a portion of the first lead-out part protruding from the first flange serves as the first end of the first connector, a portion of the conductive column protruding from the first flange serves as the second end of the first connector.

21. The relay according to claim 20, wherein the second connector is U-shaped and has a first connection portion, a second connection portion and a third connection portion connected in sequence, at least the second connection portion is embedded in the first flange of the bobbin, the first connection portion and the third connection portion both extend along the first horizontal direction and protrude from the side of the first flange; a portion of the first connection portion protruding from the first flange servs as the third end of the second connector, a portion of the third connection portion protruding from the first flange servs as the fourth end of the second connector.

22. The relay according to claim 21, wherein a groove is provided at an edge of the first flange corresponding to the third connection portion, the third connection portion protrudes from the groove; the third connection portion has flexibility, and after the third connection portion is connected to one end of the coil, the third connection portion is configured to be bendable to extend along the vertical direction.

23. The relay according to claim 21, wherein the first connector and the second connector are located at the same side of the first flange, and the first connection portion, the third connection portion and the conductive column are spaced apart along the second horizontal direction.

24. The relay according to claim 18, further comprising:
a yoke base, wherein the bobbin is placed on the yoke base; and
a lead-out member, one end of the lead-out member is connected to aside wall of the yoke base, another end is connected to another end of the capacitor.

25. The relay according to claim 24, wherein the yoke base at least has a first sidewall and a second sidewall opposite with each other, and a bottom wall connected to the first sidewall and the second sidewall, the first sidewall, the second sidewall and the bottom wall together form a chamber, the bobbin is disposed in the chamber and placed on the bottom wall; one end of the lead-out member is connected to the first sidewall of the yoke base near the capacitor.

26. The relay according to claim 25, wherein the lead-out member has a first lead-out portion, a second lead-out portion and a third lead-out portion connected in sequence, the first lead-out portion and the third lead-out portion are located at opposite sides of the second lead-out portion; the first sidewall of the yoke base is provided with an accommodating slot, the first lead-out portion is fixedly disposed in the accommodating slot, and the third lead-out portion is connected to the capacitor.

27. The relay according to claim 26, wherein the relay further comprises a circuit board, the capacitor is disposed on the circuit board, wherein the circuit board has a first through-hole, a second through-hole and a third through-hole, the second end of the first connector passes through the first through-hole and protrudes from the circuit board, the third end of the second connector passes through the second through-hole and protrudes from the circuit board, the third lead-out portion of the lead-out member passes through the third through-hole and protrudes from the circuit board.

28. The relay according to claim 15, wherein the number of the capacitor is one or more.

29. The relay according to claim 19, wherein the bobbin comprises a winding part, a first flange and a second flange, the first flange and the second flange are located at two sides of the winding part and protruding outward; the first connector has a first lead-out part and a conductive column, the conductive column is vertically connected to one end of the first lead-out part, a portion of the first connector is embedded in the first flange, the first lead-out part extends along a vertical direction and protrudes from a bottom of the first flange, the conductive column extends along a first horizontal direction and protrudes from a side of the first flange; a portion of the first lead-out part protruding from the first flange serves as the first end of the first connector, a portion of the conductive column protruding from the first flange serves as the second end of the first connector.

30. The relay according to claim 19, further comprising:
a yoke base, wherein the bobbin is placed on the yoke base; and
a lead-out member, one end of the lead-out member is connected to aside wall of the yoke base, another end is connected to another end of the capacitor.

31. A control device, comprising:
a control circuit; and
a relay comprising a coil and a capacitor,
wherein the coil is electrically connected in the control circuit, the capacitor is connected to the coil, and the capacitor is not connected in series with the coil in the control circuit.

32. A control circuit module for controlling an electronic component, comprising:
a control circuit configured to electrically connect to the electronic component; and
a capacitor electrically connected to the control circuit, wherein when the control circuit is electrically connected to the electronic component, the capacitor is not connected in series with the electronic component.

33. The control circuit module according to claim 32, wherein the electronic component is a relay, and the control circuit is configured to electrically connect to the coil of the relay.
